(19) United States
(12) Patent Application Publication
(10) Pub. No.: US 2026/0100542 A1
(43) Pub. Date: Apr. 9, 2026

(54) COMPRESSION CONTACT INTERFACE ASSEMBLIES

(71) Applicant: Molex, LLC, Lisle, IL (US)

(72) Inventors: Jack Kenyan Armitage, Naperville, IL (US); Dennis M. Breen, IV, West Chicago, IL (US); Joseph Faia, Fox Lake, IL (US); Jason W. Ferens, Sherrills Ford, NC (US); Augusto P. Panella, Naperville, IL (US); Yingfen Yi, Lisle, IL (US); William Henry Wilson, IV, Aurora, IL (US)

(21) Appl. No.: 19/340,931

(22) Filed: Sep. 26, 2025

Related U.S. Application Data
(60) Provisional application No. 63/702,658, filed on Oct. 3, 2024.

(51) Int. Cl. H01R 13/6582; H01R 12/71; H01R 13/627; H01R 13/629

(52) U.S. Cl. CPC H01R 13/6582; H01R 12/716; H01R 13/6275; H01R 13/629

(57) ABSTRACT

Compression contact interface assemblies for high-speed data communication are described. An example assembly includes an interposer assembly, a halo for securing the interposer assembly to a printed circuit board (PCB), a plug connector that mates with the interposer assembly, and a latch clip that extends over the plug connector, clips into the halo, and secures the plug connector to the interposer assembly. The interposer assembly includes an interposer housing and an interposer conductive gasket positioned over a board-mating interface region of the interposer housing. The plug connector includes a plug housing and a plug conductive gasket positioned over a mating interface of the plug housing. The halo spans over the PCB and compresses the interposer assembly down upon a top surface of the PCB. The conductive gaskets offer additional shielding, and the interposer housing and interposer conductive gasket form a ground return path for data communication through the interface assembly.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

High data rate connectors, cable assemblies, and interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signals pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. To achieve the desired mechanical and electrical requirements, the connectors used in such applications often incorporate one or more wafer assemblies. The use of wafer assemblies can be helpful to manufacture connectors capable of achieving high data rates using a number of different assembly processes.

### SUMMARY

Various aspects and embodiments of compression contact interface assemblies are described. An example assembly includes an interposer assembly, a halo for securing the interposer assembly to a printed circuit board (PCB), a plug connector that mates with the interposer assembly, and a latch clip that extends over the plug connector, clips into the halo, and secures the plug connector to the interposer assembly. The interposer assembly includes an interposer housing and an interposer conductive gasket positioned over a board-mating interface region of the interposer housing. The plug connector includes a plug housing and a plug conductive gasket positioned over a mating interface of the plug housing. The halo spans over the PCB and compresses the interposer assembly down upon a top surface of the PCB. The conductive gaskets offer additional shielding, and the interposer housing and interposer conductive gasket form a ground return path for data communication through the interface assembly.

In other aspects of the embodiments, the interposer housing is plated with metal. The interposer conductive gasket and the interposer housing act as a ground return path for the interposer assembly and the compression contact interface assembly. The interposer housing also includes terminal openings that extend from a top surface to a bottom surface of the interposer housing. A number of terminal pair plugs are secured within the terminal openings, and terminal conductors of the terminal pair plugs extend into openings of the interposer conductive gasket.

In still other aspects, the interposer housing includes one or more alignment stubs and interlock detents. The alignment stubs and interlock detents of the interposer housing fit and mate into stub recesses and detent recesses of the halo, to align them together. The interposer housing also includes one or more alignment pins that are secured with the interposer housing and extend beyond an outer surface of the interposer housing. The alignment pins can secure and align the interposer housing over the PCB.

In other aspects, the halo includes anchor ends and compression rails that extend between the anchor ends. The compression rails include the stub recesses and detent recesses. The anchor ends also include clip recesses. The latch clip includes spring arms with latching teeth, and the latching teeth mechanically interfere into the clip recesses of the halo.

The plug connector includes one or more wafer assemblies positioned in the plug housing. An example wafer assembly includes a channel shield, a pair of signal terminals extending within the channel shield, and a terminal insert extending within the channel shield. Another example wafer assembly includes a plurality of channel shields and signal terminals extending within the channel shields, a conductive cable clamp that extends over and is electrically coupled to the plurality of channel shields, a shield plate that extends over and is electrically coupled to the plurality of channel shields, and a wafer overmold.

An example connector assembly includes an interposer assembly and a plug connector that mates with the interposer assembly. The interposer assembly includes an interposer housing and an interposer conductive gasket positioned over a board-mating interface region of the interposer housing. The plug connector includes a plug housing and a plug conductive gasket positioned over a mating interface of the plug housing. The connector assembly can also include a halo for securing the interposer assembly to a PCB, and a latch clip that extends over the plug connector, clips into the halo, and secures the plug connector in a mated position with the interposer assembly.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example computing system with compression contact interface assemblies according to various aspects of the present disclosure.

FIG. 1B illustrates another perspective view of the computing system shown in FIG. 1A with an exploded view of the components of one of the compression contact interface assemblies according to various aspects of the present disclosure.

FIG. 1C illustrates a side view of the computing system shown in FIG. 1B according to various aspects of the present disclosure.

FIG. 1D illustrates another perspective view of the computing system shown in FIG. 1A, with parts omitted, according to various aspects of the present disclosure.

FIG. 2A illustrates a top perspective view of an interposer assembly shown in FIGS. 1B and 1C according to various aspects of the present disclosure.

FIG. 2B illustrates a top view of the interposer assembly shown in FIG. 2A according to various aspects of the present disclosure.

FIG. 2C illustrates a bottom view of the interposer assembly shown in FIG. 2A according to various aspects of the present disclosure.

FIG. 2D illustrates a bottom perspective view of the interposer assembly shown in FIG. 2A according to various aspects of the present disclosure.

FIG. 2E illustrates another bottom perspective view of the interposer assembly shown in FIG. 2A according to various aspects of the present disclosure.

FIG. 2F illustrates a side view of the interposer assembly shown in FIG. 2A according to various aspects of the present disclosure.

FIG. 2G illustrates another side view of the interposer assembly shown in in FIG. 2A according to various aspects of the present disclosure.

FIG. 2H illustrates the detail view D1 of the interposer assembly shown in FIG. 2E according to various aspects of the present disclosure.

FIG. 2I illustrates an array of terminal pair plugs of the interposer assembly shown in FIG. 2A according to various aspects of the present disclosure.

FIG. 2J illustrates a perspective view of one of the terminal pair plugs shown in FIG. 2I according to various aspects of the present disclosure.

FIG. 2K illustrates a side view of one of the terminal pair plugs shown in FIG. 2I according to various aspects of the present disclosure.

FIG. 3A illustrates a perspective view of an interposer halo and latch clip of the compression contact interface assembly shown in FIG. 1A according to various aspects of the present disclosure.

FIG. 3B illustrates a side view of the interposer halo and latch clip of the compression contact interface assembly shown in FIG. 1A according to various aspects of the present disclosure.

FIG. 3C illustrates a bottom view of the interposer halo shown in FIG. 3A according to various aspects of the present disclosure.

FIG. 3D illustrates the sectional view of the interposer halo designated A-A in FIG. 3A according to various aspects of the present disclosure.

FIG. 3E illustrates the sectional view of the interposer halo designated B-B in FIG. 3A according to various aspects of the present disclosure.

FIG. 4A illustrates a top perspective view of the plug connector of the compression contact interface assembly shown in FIG. 1A according to various aspects of the present disclosure.

FIG. 4B illustrates a bottom perspective view of the plug connector shown in FIG. 4A according to various aspects of the present disclosure.

FIG. 4C illustrates wafer assemblies of the plug connector shown in FIG. 4A according to various aspects of the present disclosure.

FIG. 4D illustrates an exploded view of a wafer assembly shown in FIG. 4C according to various aspects of the present disclosure.

FIG. 4E illustrates a terminal assembly of the wafer assembly shown in FIG. 4D according to various aspects of the present disclosure.

FIG. 4F illustrates another view of the terminal assembly shown in FIG. 4E according to various aspects of the present disclosure.

FIG. 4G illustrates a top and internal view of the housing of the plug connector shown in FIG. 4A according to various aspects of the present disclosure.

FIG. 5 illustrates the sectional view through the plug connector and the interposer assembly designated C-C in FIG. 1A according to various aspects of the present disclosure.

### DETAILED DESCRIPTION

Connectors are typically designed to meet a range of mechanical and electrical requirements. Some connector assemblies are designed for use in backplane and other applications that depend upon high conductor density and data rates. To achieve the mechanical and electrical requirements needed for such applications, connectors often incorporate one or more wafer assemblies. It is challenging in any case to design connectors having the conductor density, size, and electrical performance needed for high data rate applications in new and emerging computing systems.

Aspects and embodiments of compression contact interface assemblies are described herein. An example assembly includes an interposer assembly, a halo for securing the interposer assembly to a printed circuit board (PCB), a plug connector that mates with the interposer assembly, and a latch clip that extends over the plug connector, clips into the halo, and secures the plug connector to the interposer assembly. The interposer assembly includes an interposer housing and an interposer conductive gasket positioned over a board-mating interface region of the interposer housing. The plug connector includes a plug housing and a plug conductive gasket positioned over a mating interface of the plug housing. The halo spans over the PCB and compresses the interposer assembly down upon a top surface of the PCB. The conductive gaskets offer additional shielding, and the interposer housing and interposer conductive gasket form a ground return path for data communication through the interface assembly.

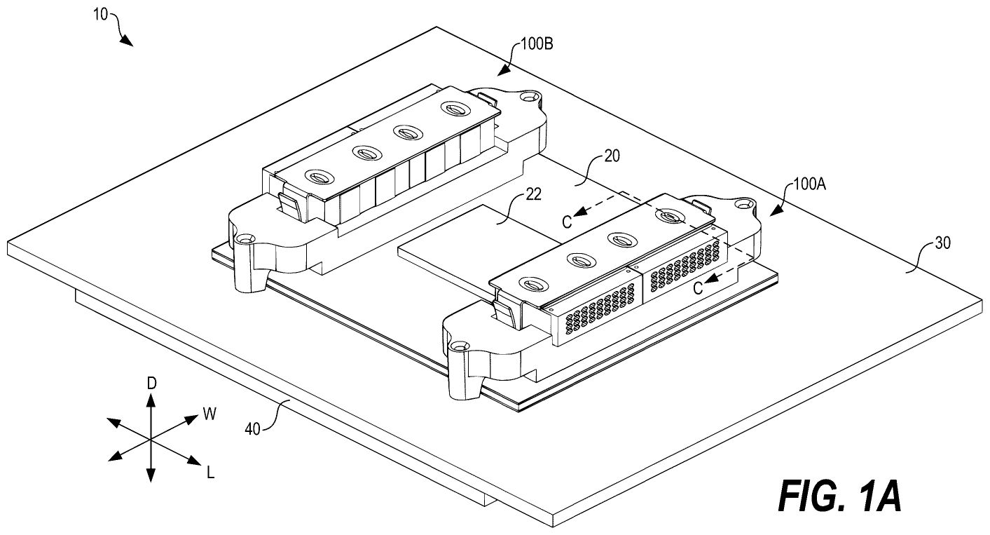

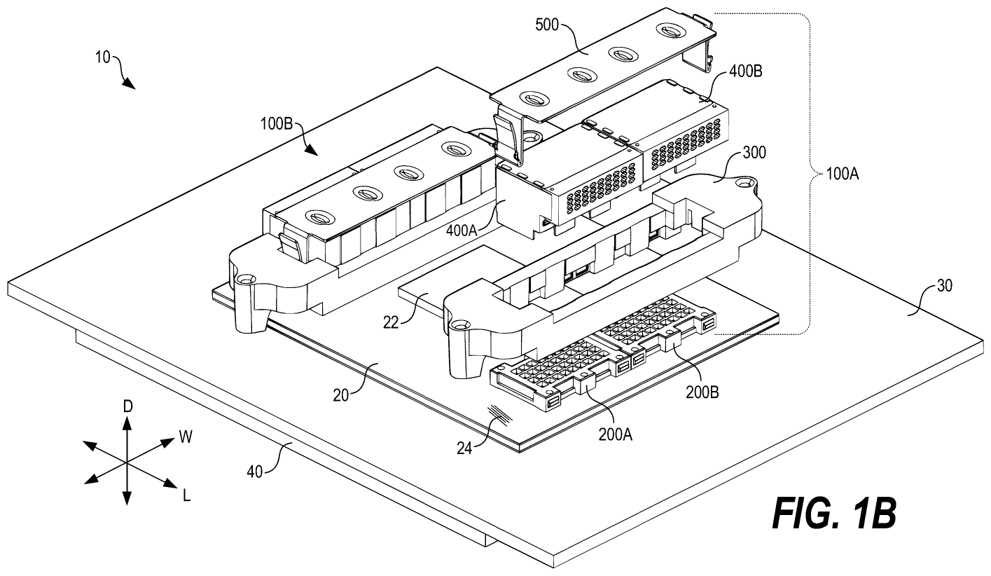

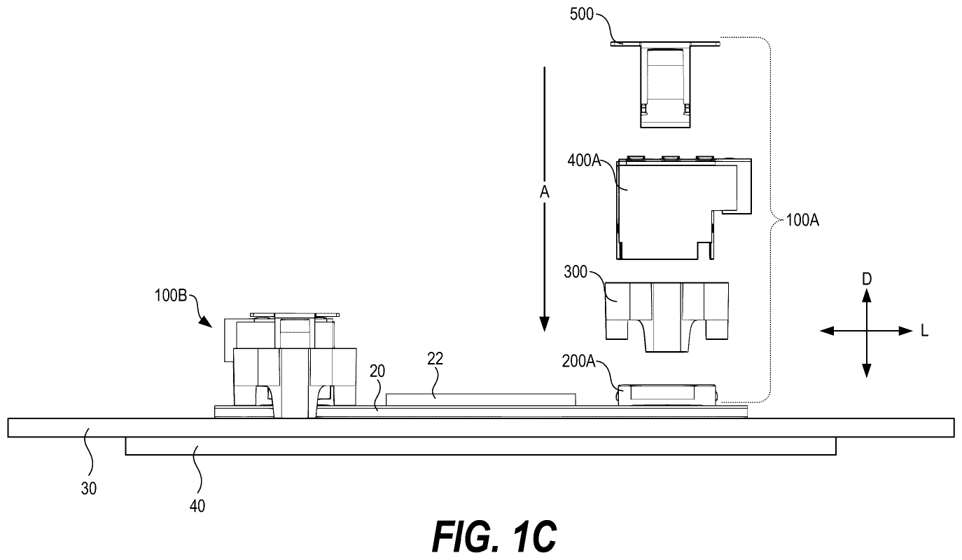

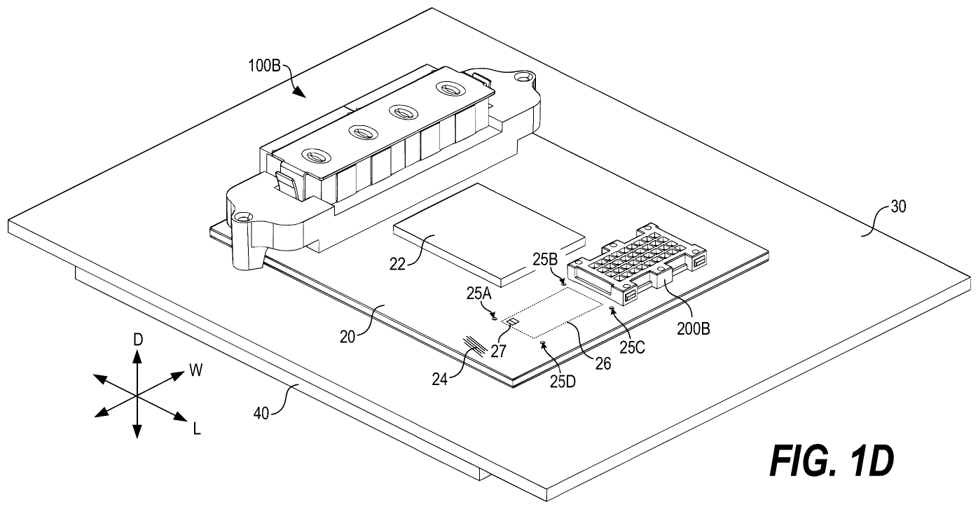

Turning to the drawings, FIG. 1A illustrates a perspective view of an example computing system 10. The computing system 10 includes a printed circuit board (PCB) 20, a substrate 30 under the PCB 20, a stiffener plate 40 under the substrate 30, a first compression contact interface assembly 100A (also “contact interface assembly 100A” or “assembly 100A”), and a second compression contact interface assembly 100B (also “contact interface assembly 100B” or “assembly 100B”), among possibly other components. FIG. 1B illustrates another perspective view of the computing system 10 shown in FIG. 1A with an exploded view of the components of the compression contact interface assembly 100A. FIG. 1C illustrates a side view of the computing system 10 shown in FIG. 1B.

The computing system 10 is illustrated as a representative example in FIGS. 1A-1C and is not drawn to any particular scale or size. The shape, size, proportion, arrangement of components, and other characteristics of the computing system 10 can vary as compared to that shown. The shape, size, proportion, arrangement of components, and other characteristics of the contact interface assemblies 100A and 100B can also vary as compared to that shown. The computing system 10 can include additional components that are not illustrated in FIGS. 1A-1C, and the computing system 10 can also omit one or more of the components that are illustrated in some cases. The contact interface assemblies 100A and 100B are suitable for use in co-package copper (CPC), on-substrate, high speed interconnect applications, such as in the computing system 10, but the concepts described herein can be extended to and used in a range of different interconnect applications and computing systems.

The PCB 20 can include a number of conductive metal layers and dielectric layers, laminated in an alternating arrangement together. The dielectric layers can be formed from a range of suitable dielectric materials, including polytetrafluoroethylene (PTFE) laminates, ceramic-filled PTFE laminates, glass microfiber reinforced PTFE laminates, other suitable dielectric laminate materials, and combinations thereof. The metal layers can include metal traces, contact pads, and related features, and plated through-hole vias can be relied upon to electrically couple the middle traces, contact pads, and other features together. The PCB 20 can include a number of contact pads on the top surface 24 (FIG. 1D) of the PCB 20 and on the bottom surface of the PCB 20.

A range of active and passive components can be mounted on and electrically coupled to the PCB 20. An integrated semiconductor device 22, for example, is mounted on and electrically coupled to the PCB 20. Other components, including resistors, capacitors, inductors, packaged integrated circuits, and other devices can also be mounted on and electrically coupled to the PCB 20, as would be understood in the field. Terminals of the contact interface assemblies 100A and 100B can also be compressed against and electrically coupled to contact pads on the top surface of the PCB 20, as described in further detail below. The contact pads are electrically coupled through the PCB 20 to the integrated semiconductor device 22 for the communication of data signals from the contact interface assemblies 100A and 100B to the integrated semiconductor device 22.

The substrate 30 can be embodied as another PCB, a molded interconnect substrate, a metallized ceramic substrate, or another type of substrate. The stiffener plate 40 can be formed from a range of materials, including metal(s), ceramic(s), and other suitable materials. In some cases, the substrate 30, the stiffener plate 40, or both can include layers or components for the distribution of heat, such as copper layers, copper, molybdenum, or copper-molybdenum slugs and other features for heat distribution.

The contact interface assemblies 100A and 100B straddle over the PCB 20, as best shown in FIG. 1A. The contact interface assemblies 100A and 100B can contact the PCB 20, but the contact interface assemblies 100A and 100B are not mechanically secured to the PCB 20. The contact interface assemblies 100A and 100B are, instead, mechanically secured to the substrate 30, the stiffener plate 40, or both. For example, the contact interface assemblies 100A and 100B are secured to the substrate 30, the stiffener plate 40, or both using fasteners, such as screws, as described in further detail below.

FIGS. 1B and 1C illustrate the parts or components of the contact interface assembly 100A. The contact interface assembly 100B is similar to the contact interface assembly 100A, and the contact interface assembly 100B can include the same components as the contact interface assembly 100A in some cases. As shown, the assembly 100A includes a first interposer assembly 200A, a second interposer assembly 200B, a first plug connector 400A, a second plug connector 400B, interposer halo 300 (also “halo 300”), and a latch clip 500. The components of the contact interface assembly 100A are arranged and secured over the PCB 20 in the manner shown in FIGS. 1B and 1C and described below. First, the interposer assemblies 200A and 200B are positioned over the PCB 20. The halo 300 is then placed down over (e.g., in the direction “A” shown in FIG. 1C) the interposer assemblies 200A and 200B. The halo 300 is then secured to (e.g., mechanically fixed to) the substrate 30, the stiffener plate 40, or both using mechanical fasteners as described below. The plug connectors 400A and 400B are then inserted into the interposer assemblies 200A and 200B, through a central opening in the halo 300, with a friction-fit between them. The latch clip 500 is then placed over the plug connectors 400A and 400B and secured with a mechanical interference to the halo 300 to hold the plug connectors 400A and 400B in place. These and other aspects of the contact interface assembly 100A are described in further detail below.

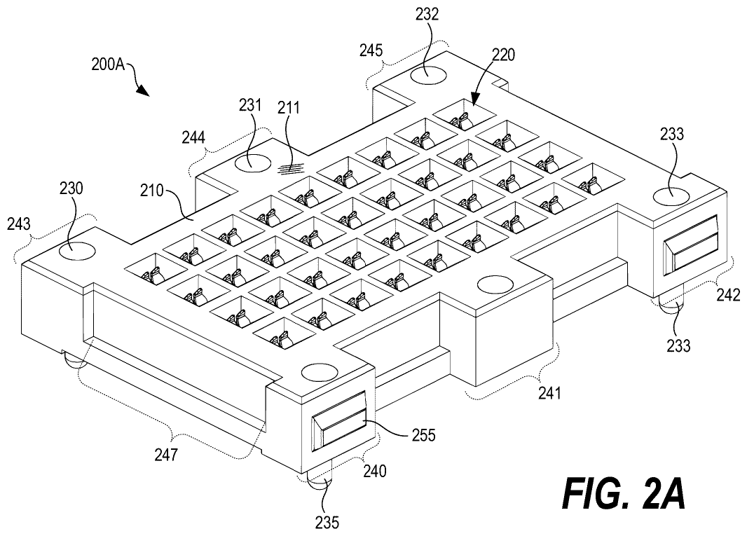

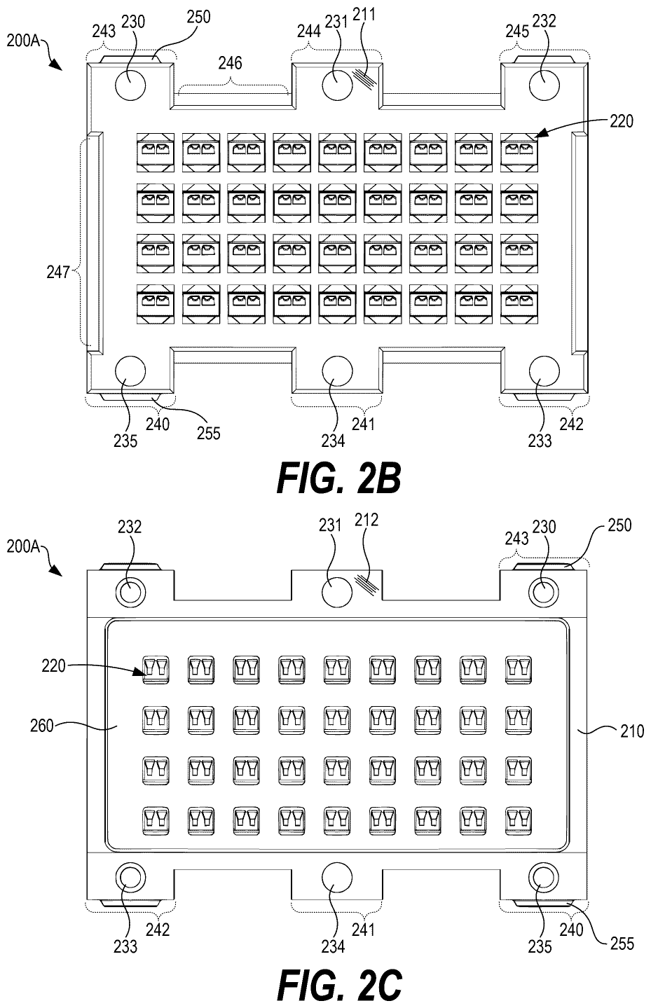

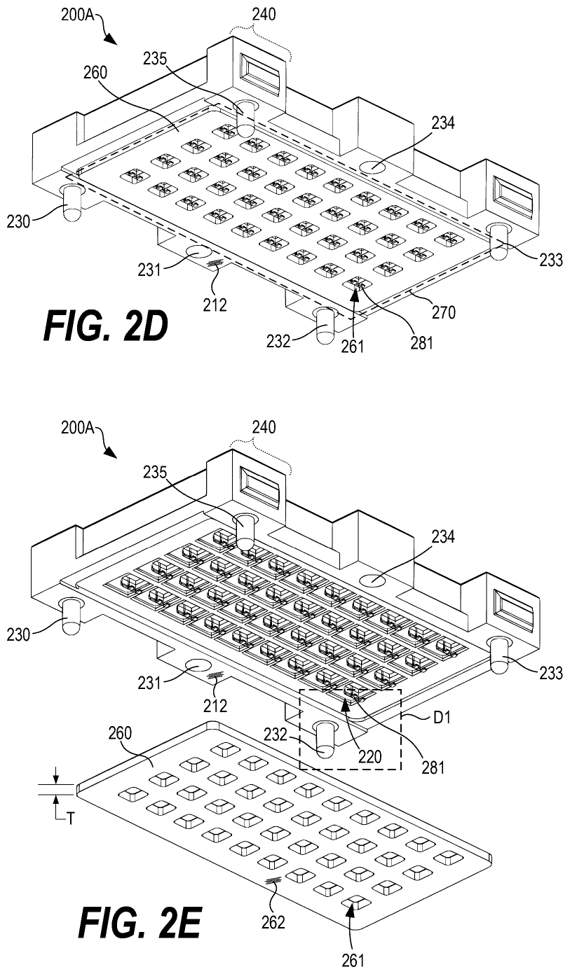

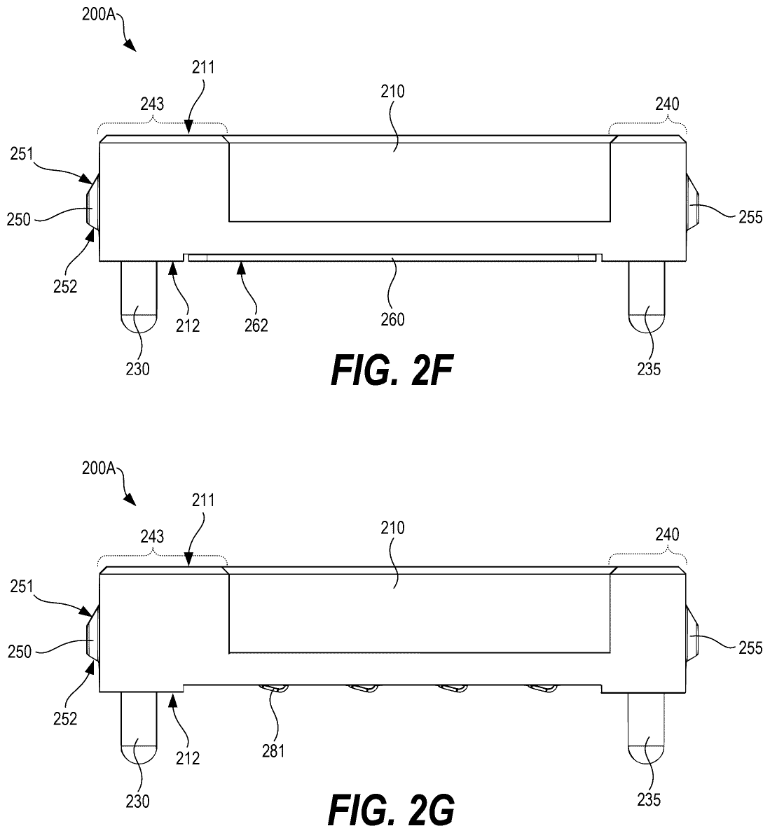

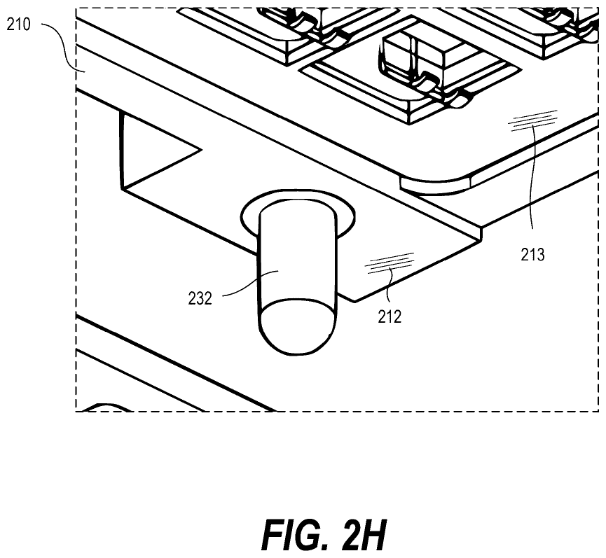

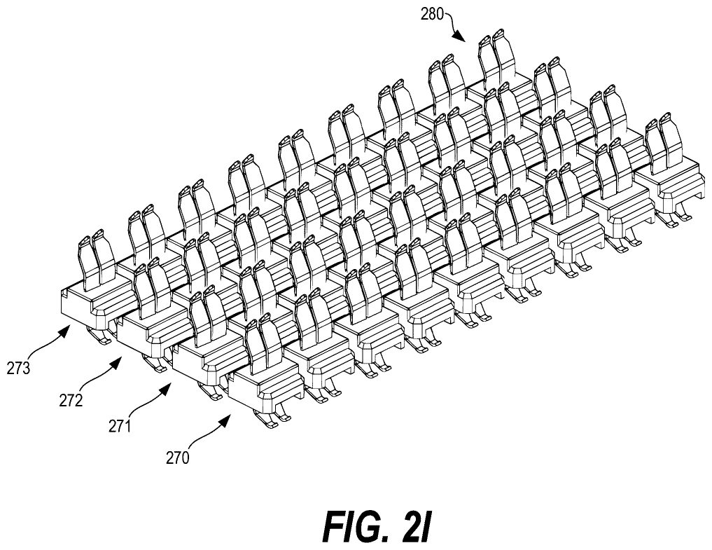

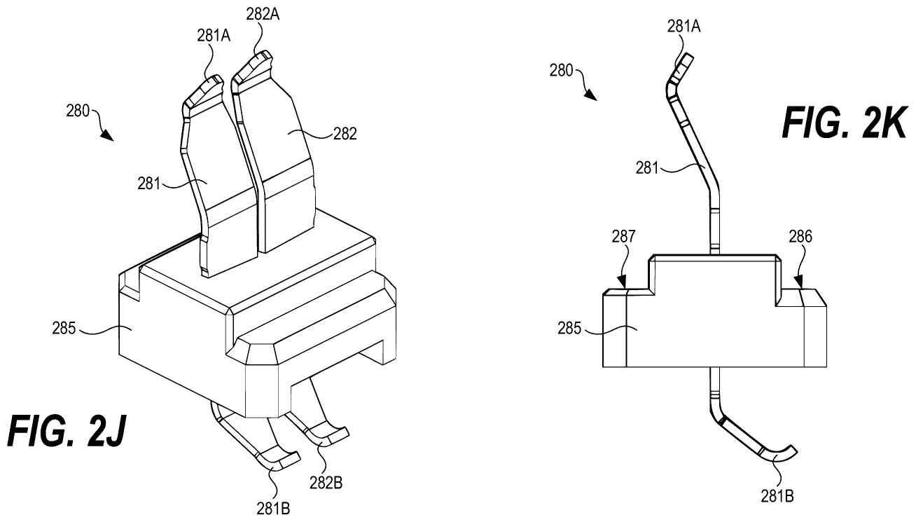

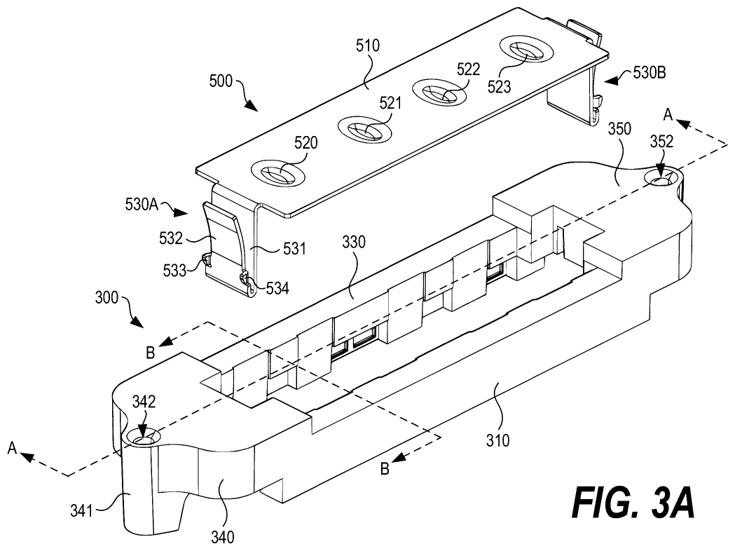

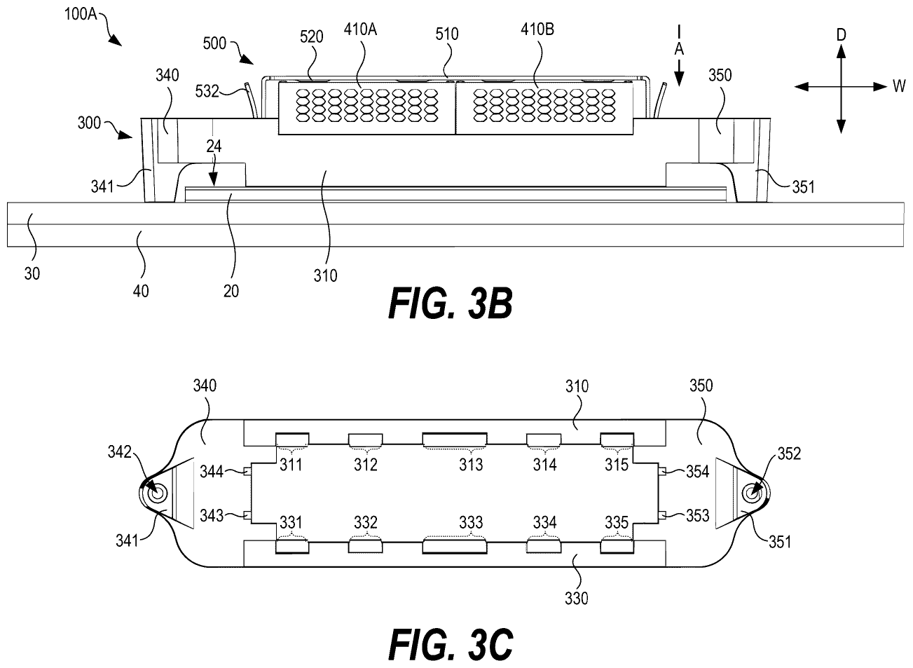

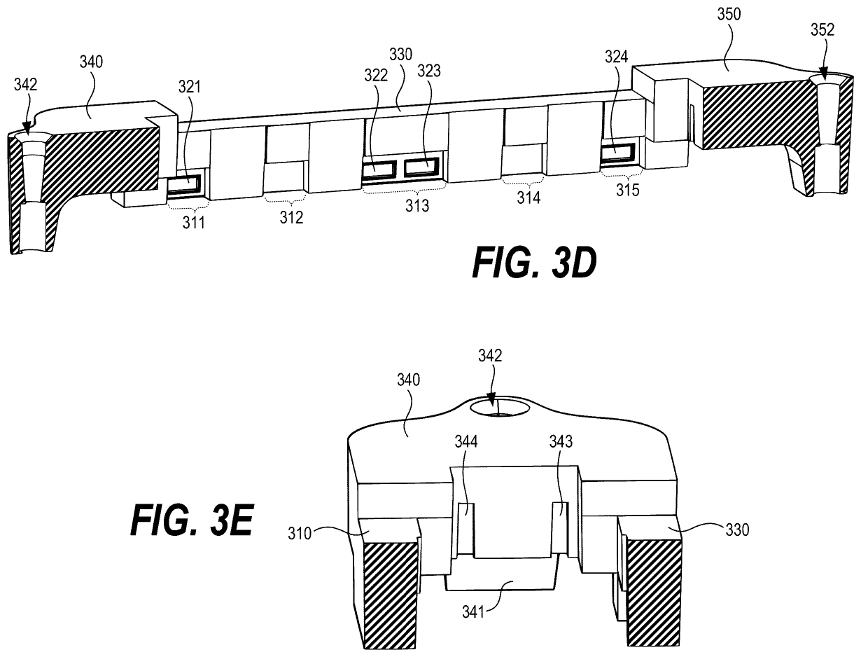

The interposer assembly 200A includes a housing, alignment pins secured with the housing, an array of terminal plug pairs positioned within the housing, a conductive gasket over a bottom surface of the housing, and other features described below with reference to FIGS. 2A-2J. The interposer assembly 200B can be the same as or similar to the interposer assembly 200A. The halo 300 includes two anchor ends, and two compression rails that extend between the anchor ends. The compression rails include alignment and interlock recesses, which help to align and position both the interposer assemblies 200A and 200B and the plug connectors 400A and 400B. Other aspects of the halo 300 are described below with reference to FIGS. 3A-3E.

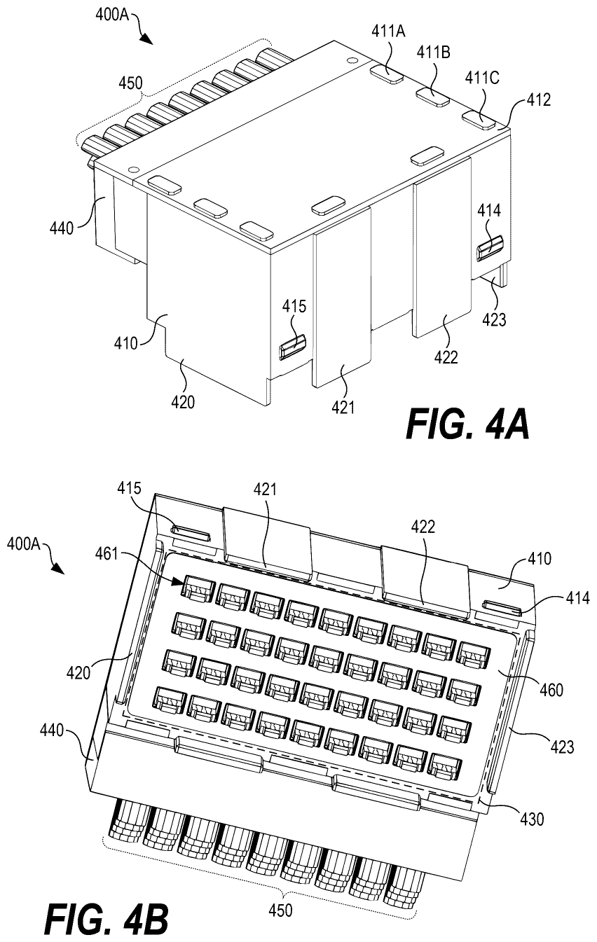

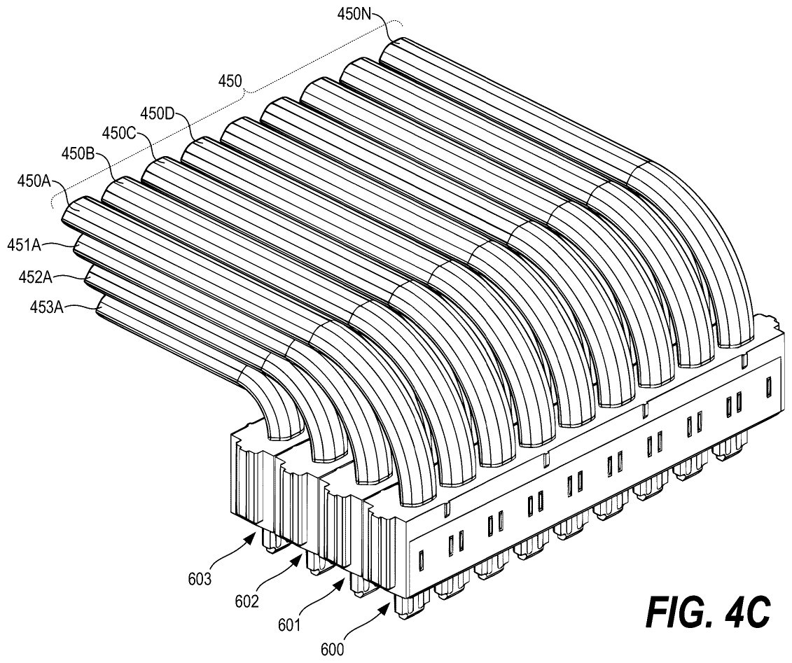

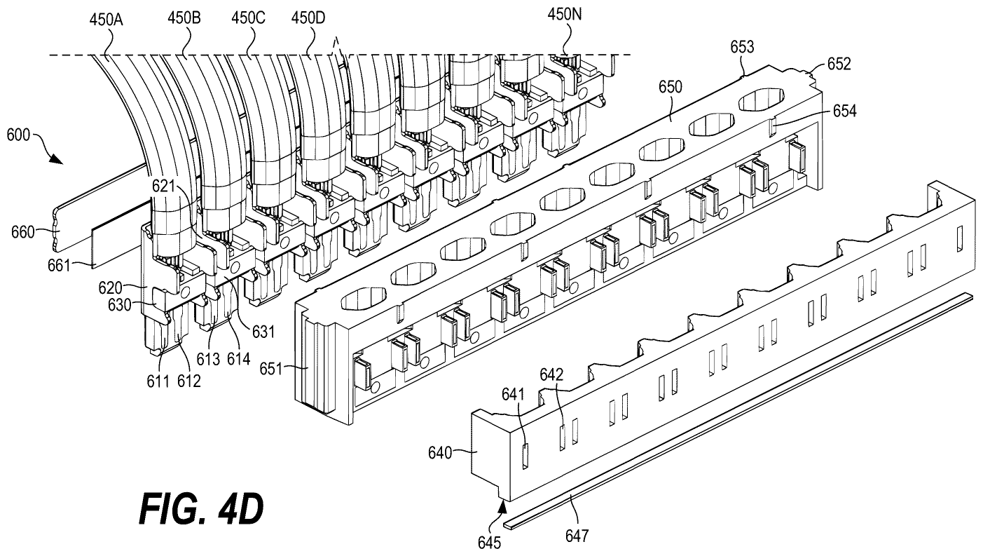

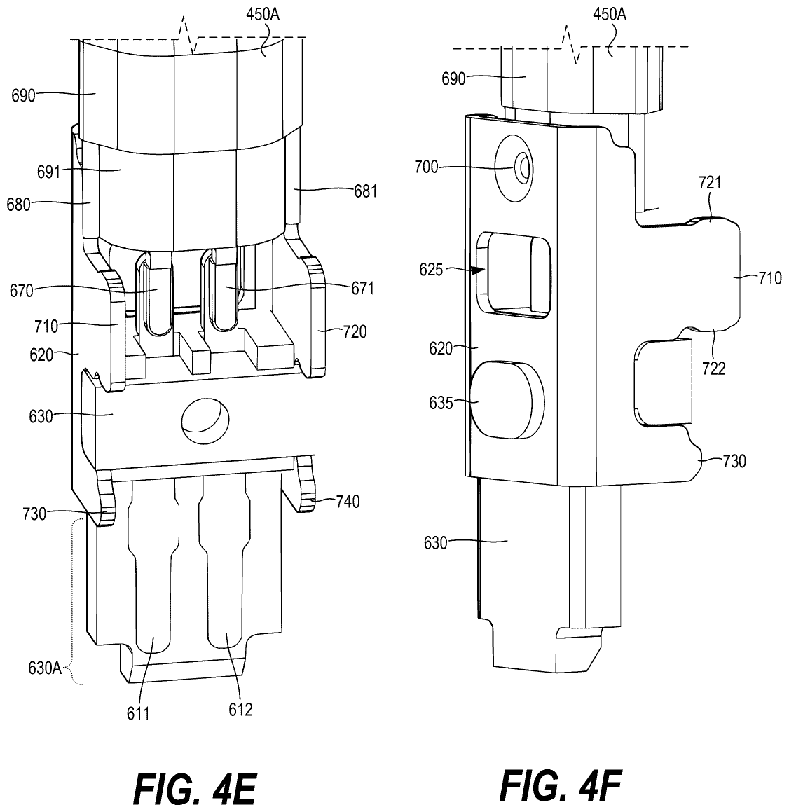

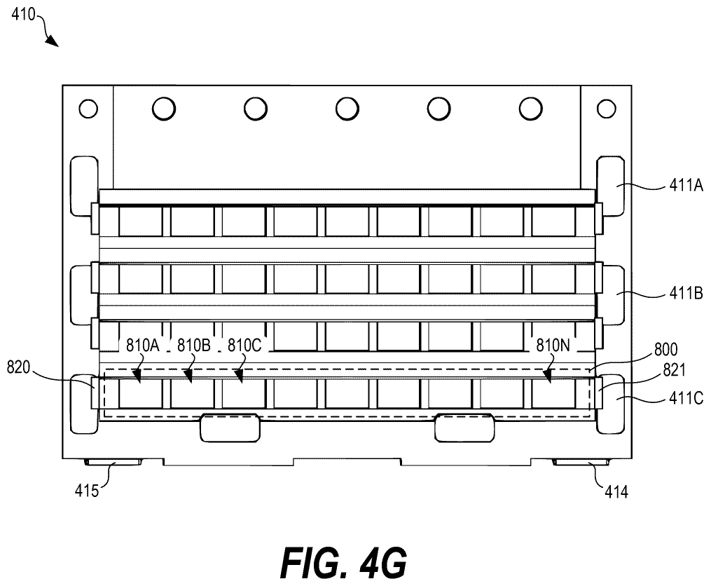

The plug connector 400A includes a plug housing having a mating interface, a conductive gasket positioned over an outer surface of the plug housing in a region of the mating interface, and a number of wafer assemblies positioned within the housing. A cable bundle (not shown in FIGS. 1A-1C) extends to the plug connector 400A, and cables among the cable bundle extend to terminal conductors of the wafer assemblies within the plug connector 400A. Other aspects of the plug connector 400A are described below with reference to FIGS. 4A-4G. The plug connector 400B can be the same as or similar to the plug connector 400A.

FIG. 1D illustrates another perspective view of the computing system 10 shown in FIG. 1A, with parts omitted. More particularly, the plug connectors 400A and 400B, halo 300, and latch clip 500 are omitted from view in FIG. 1D, so that more of the top surface 24 of the PCB 20 is visible. The interposer assembly 200B is shown on the PCB 20, but the interposer assembly 200A is also omitted from view. The PCB 20 includes positioning apertures or openings 25A-25D. As described in further detail below, the interposer assembly 200A includes alignment pins that extend beyond an outer surface of the housing of the interposer assembly 200A. The alignment pins can be positioned and inserted into the positioning apertures 25A-25D of the PCB 20, to align the interposer assembly 200A over the PCB 20. By the alignment pins extending into the positioning apertures 25A-25D, the interposer assembly 200A can be reliably aligned on the PCB 20 during installation and retained in its intended position.

FIG. 1D also illustrates an example contact pad region 26 on the top surface 24 of the PCB 20. The contact pad region 26 is positioned between (e.g., centered between) the positioning apertures 25A-25D. A number of conductive contact pads, including the contact pad pair 27, are positioned and exposed within the contact pad region 26. Signal terminals of the interposer assembly 200A are contacted and compressed against the contact pads within the contact pad region 26, establishing electrical contact for data signal communication between them. Exposed regions of a ground shield, ground contact pads, or similar ground contact regions of the PCB 20 can also be positioned and exposed within the contact pad region 26. A conductive gasket of the interposer assembly 200A is also contacted and compressed against the ground contact pads within the contact pad region 26. The concepts described herein can rely upon contact and compression between the signal terminals and conductive gaskets of the interposer assemblies 200A and 200B and contact pads on the PCB 20. In other cases, the signal terminals of the interposer assembly 200A can be soldered to the contact pads on the PCB 20, and other connections are within the scope of the embodiments.

In the example depicted in FIGS. 1A-1D, the computing system 10 relies upon two contact interface assemblies 100A and 100B as an interface between cable bundles (not shown in FIGS. 1A-1D, see FIGS. 4A and 4B) and the integrated semiconductor device 22, with the PCB 20 therebetween. The cable bundles extend to the contact interface assemblies 100A and 100B, and the contact interface assemblies 100A and 100B electrically couple data signals between the cable bundles and the conductive contacts and traces on the PCB 20. The contacts and traces on the PCB 20 are electrically coupled with the integrated semiconductor device 22, which is also mounted on and electrically coupled to contacts and traces on the PCB 20. The integrated semiconductor device 22 can be embodied as an application specific integrated circuit (ASIC), a central processing unit (CPU), a graphics processing unit (GPU), or another integrated circuit device. The integrated semiconductor device 22 can be packaged in a flip-chip, surface-mount, ball grid array, or other suitable semiconductor device package. Although two contact interface assemblies 100A and 100B are relied upon in the computing system 10, additional or fewer contact interface assemblies can be relied upon in other cases.

FIG. 2A illustrates a top perspective view of the interposer assembly 200A shown in FIGS. 1B and 1C. FIG. 2B illustrates a top view, FIG. 2C illustrates a bottom view, and FIG. 2D illustrates a bottom perspective view of the interposer assembly 200A shown in FIG. 2A. The interposer assembly 200A includes an interposer housing 210, a number of pins 230-235 embedded within the interposer housing 210, and an interposer conductive gasket 260 positioned over a board-mating interface region of the interposer housing 210. The interposer assembly 200A is illustrated as a representative example and is not drawn to any particular scale or size. The shape, size, proportion, and other characteristics of the interposer assembly 200A can vary as compared to that shown in other embodiments. The interposer assembly 200B can be the same as the interposer assembly 200A in preferred embodiments, although the interposer assemblies 200A and 200B can vary as compared to each other in some cases.

The interposer housing 210 has a top surface 211, a bottom surface 212, and rows of terminal openings. Each terminal opening extends through the interposer housing 210 from the top surface 211 to the bottom surface 212. For example, the terminal opening 220 extends through the interposer housing 210 from the top surface 211 to the bottom surface 212. The pins 230-235 are embedded within and, in some cases, extend in part beyond the bottom surface 212 of the interposer housing 210. The pins 230-235 help to align the interposer assembly 200A over the PCB 20 and provide additional strength and rigidity to the interposer housing 210, as described below. The interposer assembly 200A also includes a number of terminal pair plugs, each of which is secured within a respective terminal opening in the interposer housing 210. An example terminal pair plug is described below with reference to FIGS. 2J and 2K. The conductive gasket 260 is positioned over a board-mating interface region 270 of the interposer housing 210, as shown in FIG. 2D. Each of the components of the interposer assembly 200A is described in further detail below.

The interposer housing 210 can be formed from a plastic or polymer, such as liquid crystal polymer (LCP), polyethylene (PE), polytetrafluoroethylene (PTFE), fluoropolymer, or other plastic or insulating material(s). The interposer housing 210 can be formed using any suitable additive or subtractive manufacturing techniques, including molding, injection molding, printing, and other techniques. Outer surfaces of the interposer housing 210 are selectively metalized or plated with a plating metal or metals for conductivity in some embodiments, and the interposer housing 210 can be embodied as a plated plastic component. In one embodiment, the entirety of all exterior-facing outer surfaces of the interposer housing 210, including the surface regions within the terminal openings, are plated with a metal or metals for conductivity. In other cases, only certain interior and/or exterior surfaces or surface regions of the interposer housing 210 are plated. As an example, the top surface 211, the bottom surface 212, and the inner surfaces within the terminal openings of the interposer housing 210 can be plated, and the side surfaces of the interposer housing 210 can lack plating. The plating facilitates the use of the interposer housing 210 as a common drain or ground connection of the larger interposer assembly 200A, as well as a type of electromagnetic interference (EMI) shield, as described in further detail below. Notably, as described below, the terminal pair plugs that are seated within the terminal openings of the interposer assembly 200A do not include separate metal terminals for common, ground, or drain connections. The interposer housing 210 can also be formed from a conductive material other than a plastic or polymer in other cases. The interposer housing 210 can also be formed from aluminum, copper, brass, or another metal or metal alloy as an alternative to plastic. The interposer housing 210 can be self-conductive in that case without surface plating.

The plated surfaces of the interposer housing 210 can be etched in some cases and metalized or plated in a bath, barrel plated, plated by physical vapor deposition (PVD), plated by electroless plating, electroplating, sputter plating, ion plating, or other plating techniques or a combination thereof. The surfaces of the interposer housing 210 can be metalized or plated with copper, nickel, tin, silver, other plating metals, or combinations of plating metals. In another metallization approach, the material from which the interposer housing 210 is formed can include a laser direct structuring (LDS) additive. A laser beam can be used to activate the LDS additive over certain surfaces or surface areas of the interposer housing 210 for metallization. A subsequent metallization process can be performed by submerging the interposer housing 210 in a bath, and conductive metal plating can adhere to the activated surfaces or surface areas of the interposer housing 210. A number of different layers of metal, such as copper, nickel, tin, gold, or other plating metals or combinations thereof can be successively plated in that approach.

The interposer housing 210 includes a number of alignment stubs, such as the alignment stubs 240-246, among others. The alignment stubs 240, 242, 243, and 245 are shaped as rectangular blocks, and each is positioned at a respective corner of the interposer housing 210. The alignment stub 241 is shaped as a rectangular block and is positioned along one side of the interposer housing 210, the alignment stub 244 is also shaped as a rectangular block and is positioned along another side of the interposer housing 210, and so forth. The interposer housing 210 also includes a number of slot recesses, such as the slot recesses 246 and 247 (FIG. 2B) and others, which are positioned around the outer periphery of the interposer housing 210. Alignment tabs of the plug connector 400A extend and fit into the slot recesses of the interposer housing 210 when the plug connector 400A is mated with the interposer housing 210.

The pins 230-235 can be embodied as metal pins that are embedded and secured, at least in part, within the interposer housing 210. The interposer housing 210 can be molded around the pins 230-235 in some cases, although the pins 230-235 can also be positioned and secured in the interposer housing 210 in other ways. The pins 230-235 provide additional strength to the interposer housing 210 and particularly against compressive forces applied by the interposer halo 300. Some of the pins 230-235 also extend beyond the bottom surface 212 of the interposer housing 210. As shown in FIG. 2D, for example, the pins 230, 232, 233, and 235, which are at the corners of the interposer assembly 200A, extend beyond the bottom surface 212 of the interposer housing 210. The pins 230, 232, 233, and 235 can be referred to as alignment pins. The alignment pins 230, 232, 233, and 235 can be positioned over and inserted into the apertures 25A-25D on the top surface 24 of the PCB 20, as also described above, to control the position and alignment of the interposer assembly 200A over the PCB 20. The alignment pins 230, 232, 233, and 235 are formed to have hemispherical ends in the example depicted in FIG. 2D. In other cases, the ends of the alignment pins 230, 232, 233, and 235 can be conical in shape or tapered in other ways for centering within the apertures 25A-25D.

As shown in FIG. 2D, the conductive gasket 260 of the interposer assembly 200A is positioned and secured over a bottom mating surface of the interposer housing 210, and FIG. 2E illustrates the conductive gasket 260 separated from the interposer housing 210. The conductive gasket 260 can be embodied as a conductive, elastomeric gasket formed from an elastic and compressible material, such as conductive foam. As one example, the conductive gasket 260 can be embodied as a polyurethane foam multi-laminate including conductive materials, such as copper, nickel, or other conductive metals or materials disposed therein. In one particular example, the conductive gasket 260 can be embodied as the P-SHIELD® brand PS-1323 conductive foam sheet or tape manufactured by Polymer Science, Inc. of Monticello, Indiana, although other suitable types of conductive elastomeric or foam materials can be relied upon. The conductive gasket 260 can range in thickness “T,” as identified in FIG. 2E, from between 0.1-5 mm, and example thicknesses include 0.5 mm, 1.0 mm, 1.5 mm, 2.0 mm, 2.5 mm, 2.5 mm, 3.0 mm, 3.5 mm, 4.0 mm, 4.5 mm, and 5.0 mm, although other thicknesses can be relied upon.

Due to its elastomeric properties, the conductive gasket 260 can be compressed against the top surface 24 of the PCB 20, making continuous contact with it, even if the top surface 24 includes irregularities and does not extend in an exact plane. The conductive gasket 260 can achieve better contact with surfaces, such as the top surface 24 of the PCB 20, particularly if the top surface 24 is irregular due to manufacturing tolerances. The enhanced shielding provided by the conductive gasket 260 helps to maintain signal integrity and higher data throughput for the contact interface assembly 100A.

The conductive gasket 260 includes rows of apertures or openings, such as the opening 261, among others. The openings permit the signal terminal conductors of the interposer assembly 200A to extend through the conductive gasket 260 and to contact the top surface 24 (FIG. 1D) of the PCB 20. As shown in FIG. 2D, for example, the signal terminal conductor 281 of the terminal pair plug 280 (see FIGS. 2J and 2K) is positioned within the opening 261 of the conductive gasket 260. Additional aspects of the conductive gasket 260 are described below.

FIG. 2F illustrates a side view of the interposer assembly 200A shown in in FIG. 2A, and FIG. 2G illustrates another side view of the interposer assembly 200A. The conductive gasket 260 is omitted from view in FIG. 2G. The interposer assembly 200A includes an interlock detent at each corner of the interposer housing 210. For example, the interposer housing 210 includes the interlock detents 250 and 255 on outer surfaces of the alignment stubs 243 and 240, respectively, as shown in FIGS. 2F and 2G. The interlock detents of the interposer assembly 200A fit or snap into corresponding detent recesses of the interposer halo 300, as described in further detail below.

The interlock detent 250 includes a first angled surface 251 and a second angled surface 252, as also shown in FIGS. 2F and 2G. The first angled surface 251 is closer to the top surface 211 of the interposer assembly 200A, and the second angled surface 252 is closer to the bottom surface 212 of the interposer assembly 200A. The first angled surface 251 is angled at a different angle or pitch with respect to the top surface 211 than the second angled surface 251 is angled with respect to the bottom surface 212. More particularly, the first angled surface 251 extends at an angle that is closer to being perpendicular to the top surface 211 than the second angled surface 252 extends with respect to the bottom surface 212. Stated another way, the second angled surface 252 extends at an angle that is closer to being parallel to the bottom surface 212 than the first angled surface 251 extends with respect to the top surface 211.

As noted above, the interlock detent 250 of the interposer assembly 200A fits or snaps into a corresponding detent recess of the interposer halo 300, as the interposer halo 300 is placed down over (e.g., in the direction “A” shown in FIG. 1C) the interposer assembly 200A. The first angled surface 251 facilitates the interposer halo 300 being snapped over the interlock detent 250 with a first amount of force. The second angled surface 252 of the interlock detent 250 prevents the interposer halo 300 from being removed from the interposer assembly 200A unless a second, and greater, amount of force is applied to remove it. These and other aspects of the embodiments are described in further detail below.

Comparing FIGS. 2F and 2G, the signal terminal conductor 281 is visible in FIG. 2G, but the signal terminal conductor 281 is obscured by the conductive gasket 260 in FIG. 2F. In the example shown, the conductive gasket 260 can provide a ground shield for the signal terminal conductor 281, among others, of the interposer assembly 200A. Both the conductive gasket 260 and the signal terminal conductors of the interposer assembly 200A can be contacted against and compressed down upon the top surface 24 of the PCB 20, as described above with reference to FIG. 1D.

FIG. 2H illustrates the detail view D1 of the interposer assembly 200A shown in FIG. 2E. The conductive gasket 260 is omitted from view in FIG. 2E, so that the recessed surface 213 of the interposer housing 210 is visible. The recessed surface 213 extends in a plane that is different than the bottom surface 212 of the interposer assembly 200A in the example shown. In some cases, however, the recessed surface 213 can be omitted, and the interposer housing 210 can be formed to have a single, coextensive bottom surface.

The conductive gasket 260 can be positioned and secured to the recessed surface 213 of the interposer housing 210 in the example shown. A conductive adhesive, for example, can be applied between the recessed surface 213 of the interposer housing 210 and the conductive gasket 260, to secure the conductive gasket 260 to the interposer housing 210. The extent (i.e., the distance) to which the recessed surface 213 is recessed as compared to the bottom surface 212 of the interposer assembly 200A can be selected or chosen in connection with the thickness “T” of the conductive gasket 260. Depending on the design of the recessed surface 213 and the thickness “T” of the conductive gasket 260, the lower surface 262 (see FIG. 2F) of the conductive gasket 260 can extend in the same plane, or in a different plane, with respect to the bottom surface 212 of the interposer assembly 200A. In some cases, the lower surface 262 of the conductive gasket 260 extends in a plane that is different, and lower, than the bottom surface 212 of the interposer assembly 200A. The relative positions of the lower surface 262 of the conductive gasket 260 and the bottom surface 212 of the interposer assembly 200A can vary among the embodiments however, depending on design parameters.

FIG. 2I illustrates an array of terminal pair plugs of the interposer assembly 200A shown in FIG. 2A. The array includes rows 270-273 of terminal pair plugs. The array includes thirty-six (36) terminal pair plugs among the rows 270-273 in the example shown, although the interposer assembly 200A can be modified for use with any number of terminal pair plugs. The terminal pair plug 280 is at one end of the row 273. Each of the terminal pair plugs in the array can be the same as the terminal pair plug 280 in a preferred embodiment, but two or more of the terminal pair plugs can vary as compared to each other in some cases. The terminal pair plugs are seated and positioned in the interposer housing 210 when it is assembled, as shown in FIG. 2A, and each terminal pair plug is positioned within a terminal opening that extends through the interposer housing 210. The terminal pair plug 280, for example, is positioned and seated within the terminal opening 220 (see FIG. 2A) of the interposer housing 210, and the other terminal pair plugs are positioned within other terminal openings of the interposer housing 210.

FIG. 2J illustrates a perspective view of the terminal pair plug 280 shown in FIG. 2I, and FIG. 2K illustrates a side view of the terminal pair plug 280 shown in FIG. 2I. The terminal pair plug 280 includes signal terminal conductors 281 and 282 and a terminal base 285. The signal terminal conductors 281 and 282 are conductive and suitable for the communication of a differential data signal. The signal terminal conductors 281 and 282 are shaped and designed to contact a corresponding pair of terminal conductors in the plug connector 400A, when the plug connector 400A is mated with the interposer assembly 200A, as described in further detail below. Thus, the signal terminal conductors 281 and 282 communicate data from the plug connector 400A, through the interposer assembly 200A, and to the PCB 20 in the computing system 10 shown in FIG. 1A.

The signal terminal conductors 281 and 282 are conductive and can be formed from metal. The signal terminal conductors 281 and 282 include leading contact tips and compression tails. For example, the signal terminal conductor 281 includes a contact tip 281A and a compression tail 281B. The signal terminal 282 also includes a contact tip 282A and a compression tail 282B. The terminal base 285 is an insulator and can be formed from a plastic or polymer, such as LCP, PE, PTFE, fluoropolymer, or other plastic or insulating material(s). The terminal base 285 is molded around the signal terminal conductors 281 and 282 in the example shown. In a particular example, the signal terminal conductors 281 and 282 can be formed from (e.g., stamped, sheared, or otherwise formed out of) a flat sheet of metal, such as a lead frame. The sheet of metal or lead frame can be plated with one or more plating metals in some cases. The terminal base 285 can be molded around the lead frame from which the signal terminal conductors 281 and 282 are formed, before the signal terminal conductors 281 and 282 are separated from the larger lead frame along with the terminal base 285.

The terminal base 285 of the terminal pair plug 280 includes platform surfaces 286 and 287, as identified in FIG. 2K. The platform surfaces 286 and 287 can contact and rest against surfaces within the terminal opening 220 of the interposer housing 210, when the terminal pair plug 280 is inserted into the terminal opening 220, to control the position of the terminal pair plug 280 within the interposer housing 210. The terminal pair plug 280 can be inserted into the terminal opening 220 of the interposer housing 210 from a bottom of the interposer housing 210, as shown in FIG. 2E, and the signal terminal conductor 281 of the terminal pair plug 280 is identified within the terminal opening 220 in FIG. 2E. The terminal pair plug 280 can be secured within the terminal opening 220 using an interference or friction fit between the terminal base 285 and inner surfaces within the terminal opening 220 in one example. The terminal base 285 can also be secured within the terminal opening 220 using adhesives, plastic welds, or other techniques in some cases. In other cases, the terminal pair plug 280 can be permitted to move or float to some extent within the terminal opening 220 based on minimal clearances between the terminal base 285 and inner surfaces within the terminal opening 220. The terminal pair plug 280 can also be secured within the terminal opening 220, at least in part, by the conductive gasket 260 covering part of the terminal opening 220.

FIG. 3A illustrates a perspective view of the interposer halo 300 and latch clip 500 of the interface assembly 100A shown in FIG. 1A. The interposer halo 300 includes compression rails 310 and 330 that extend between anchor ends 340 and 350. The compression rails 310 and 330 include alignment stub recesses and detent recesses. The alignment stub and detent recesses mate with the alignment stubs 240-246 and interlock detents 250 and 255 of the interposer assembly 200A, as described in further detail below with reference to FIGS. 3C and 3D. Additionally, the anchor ends 340 and 350 of the halo 300 include clip recesses. The clip recesses interlock with latching teeth of the latch clip 500, as described in further detail below with reference to FIGS. 3C and 3E.

The halo 300 can be formed from a relatively rigid material, such as metal, ceramic, or other material(s). In one example, the halo 300 can be formed as a die cast, high-strength steel component, for strength and rigidity. In other cases, the halo 300 can be formed from a plastic or polymer, such as LCP, PE, PTFE, fluoropolymer, or other plastic material(s), and the halo 300 can be a plated plastic component in some cases. The halo 300 can be formed using any suitable additive or subtractive manufacturing techniques, including casting, molding, injection molding, printing, and other techniques. The latch clip 500 can be formed from (e.g., stamped, sheared, or otherwise formed out of) a flat sheet of metal and bent, pressed, or otherwise formed into the shape shown in FIG. 3A and described below.

FIG. 3B illustrates a side view of the halo 300 and the latch clip 500 of the interface assembly 100A shown in FIG. 1A. The halo 300 is placed down and over the interposer assemblies 200A and 200B (e.g., in the direction “A” shown in FIG. 1C) when the interface assembly 100A is assembled over the PCB 20. As shown in FIG. 3B, the halo 300 straddles over the PCB 20. The compression rails 310 and 330 can contact the top surface 24 of the PCB 20 in some cases, or a clearance can remain between the compression rails 310 and 330 and the top surface 24 of the PCB 20 when the halo 300 is installed. In either case, the compression rails 310 and 330 of the halo 300 secure and compress the interposer assemblies 200A and 200B down and upon the top surface 24 of the PCB 20.

The halo 300 can be mechanically secured to the substrate 30, the stiffener plate 40, or both using fasteners, such as screws and threaded apertures (e.g., threaded apertures in the substrate 30 and/or the stiffener plate 40), screws and bolts, locking pins, or other fastening means. The anchor ends 340 and 350 of the halo 300 include anchor pedestals 341 and 351, respectively. The anchor pedestals 341 and 351 extend down, lower than and below the compression rails 310 and 330, so that they can rest upon the substrate 30. Apertures 342 and 352 are formed through the anchor pedestals 341 and 351 as shown in FIG. 3A. Fasteners can be inserted through the apertures 342 and 352 and through or into the substrate 30 and the stiffener plate 40, to hold the halo 300 in place over the PCB 20.

After the halo 300 is secured, the plug connectors 400A and 400B can then be inserted into the interposer assemblies 200A and 200B through the central opening in the halo 300. The latch clip 500 is then placed over the plug connectors 400A and 400B, as shown in FIG. 3B, to hold the plug connectors 400A and 400B in place. Referring back to FIG. 3A, the latch clip 500 includes a top plate 510 with contact dimples 520-523, among others, that are formed or pressed into the top plate 510. The top plate 510 of the latch clip 500 is nominally wider (i.e., in the width “W” direction shown in FIGS. 1B and 3B) than the combined top surface area of the plug connectors 400A and 400B, when the plug connectors 400A and 400B are arranged side-by-side. The underside of the contact dimples 520-523 can contact the top surface area of the plug connectors 400A and 400B when the latch clip 500 is secured into the halo 300 and over the plug connectors 400A and 400B, as best shown in FIG. 3B.

The latch clip 500 includes spring arms 530A and 530B, which are formed at opposite ends of the top plate 510. The spring arm 530A includes an extension arm 531 and a spring tab 532, and the spring arm 530B is formed in a similar way to include an extension arm and a spring tab. The extension arm 531 extends down, perpendicularly, from an end edge of top plate 510. The spring tab 532 extends back up, in a curve away from the top plate 510, from a lower end of the extension arm 531. A bend is formed between the extension arm 531 and the spring tab 532. The spring tab 532 can be elastically compressed against the extension arm 531 due to the elastic nature of the metal from which the latch clip 500 is formed and the bend between the extension arm 531 and the spring tab 532. The spring tab 532 also includes latching teeth 533 and 534 formed along side edges of the spring tab 532. The spring arm 530B is similar to the spring arm 530A.

FIG. 3C illustrates a bottom view of the halo 300 shown in FIG. 3A. The compression rail 310 includes alignment stub recesses 311-315, and the compression rail 330 includes alignment stub recesses 331-335. The alignment stub recesses 311-315 and 331-335 are cutouts or recesses in the compression rails 310 and 330. When the halo 300 is placed down over the interposer assembly 200A, the alignment stubs 240-246 (FIG. 2A) of the interposer assembly 200A fit into the stub recesses 311-313 and 331-333 in the compression rails 310 and 330, to align the halo 300 with the interposer assembly 200A. Similarly, when the halo 300 is placed down over the interposer assembly 200B, alignment stubs of the interposer assembly 200B fit into the stub recesses 313-315 and 333-335 in the compression rails 310 and 330, to align the halo 300 and the interposer assembly 200B together. Stub recesses 313 and 333 are larger to receive alignment stubs from both the interposer assembly 200A and the interposer assembly 200B.

As also shown in FIG. 3C, the anchor end 340 includes clip recesses 343 and 344, and the anchor end 350 includes clip recesses 353 and 354. The clip recesses 343, 344, 353, and 354 are formed as elongated cutout channels in the anchor ends 340 and 350. When the latch clip 500 is installed over the plug connectors 400A and 400B, the spring arms 530A and 530B occupy a space between the housings of the plug connectors 400A and 400B and the anchor ends 340 and 350 of the halo 300. The latch clip 500 can be pressed down in the direction “A” shown in FIG. 3B, until the teeth on the spring arms fall or snap into the clip recesses 343, 344, 353, and 354. For example, the latching teeth 533 and 534 of the spring tab 532 will snap into the clip recesses 343 and 344 of the anchor end 340 of the halo 300. The latching teeth 533 and 534 of the spring tab 532 will mechanically interfere with the top edges of the clip recesses 343 and 344 of the halo 300. The mechanical interference can be cleared by compression of the spring tab 532 against the extension arm 531 of the spring arm 530B. Latching teeth of the spring arm 530B also snap into the clip recesses 353 and 354 of the halo 300 in a similar way, to hold the latch clip 500 in place.

Once the spring arms 530A and 530B of the latch clip 500 are latched into the anchor ends 340 and 350 of the halo 300, respectively, the latch clip 500 will be secured in place over the plug connectors 400A and 400B. The spring bias provided by the spring arms 530A and 530B can also provide a downward force in the direction “A” shown in FIG. 3B, against the top surfaces of the plug connectors 400A and 400B. The latch clip 500 can be removed by compressing the spring arms 530A and 530B together. Compressing the spring arm 530A, for example, will release the mechanical interference between the latching teeth 533 and 534 and the clip recesses 343 and 344. Compressing the spring arm 530B will release the latching teeth of the spring arm 530B from the clip recesses 353 and 354 in a similar way, and the latch clip 500 can be removed from the halo 300.

FIG. 3D illustrates the sectional view of the halo 300 designated A-A in FIG. 3A. The inner surface of the compression rail 310 is visible in FIG. 3D. The compression rail 310 includes the alignment stub recesses 311-315. The alignment stub recesses 311-315 and 331-335 are cutouts or recesses in the compression rails 310 and 330. When the halo 300 is placed down over the interposer assembly 200A, the alignment stubs 240-246 (FIG. 2A) of the interposer assembly 200A fit into the stub recesses 311-313 in the compression rail 310, to align the halo 300 with the interposer assembly 200A. Similarly, when the halo 300 is placed down over the interposer assembly 200B, alignment stubs of the interposer assembly 200B fit into the stub recesses 313-315 in the compression rail 310, to align the halo 300 and the interposer assembly 200B together.

FIG. 3D also illustrates detent recesses 321-324. The detent recess 321 is positioned within the alignment stub recess 311. The detent recesses 322 and 323 are positioned within the alignment stub recess 313. The detent recess 324 is positioned within the alignment stub recess 315. The detent recesses 321-324 are formed as further recesses into the compression rail 310, and the compression rail 330 includes similar detent recesses. When the halo 300 is placed down over the interposer assembly 200A, the interlock detents of the interposer assembly 200A snap into the detent recesses of the halo 300. For example, the interlock detent 250 on the outer surface of the alignment stub 243 (FIG. 2F) snaps into the detent recess 321. The interlock detent 250 fits or snaps into the detent recess 321 as the interposer halo 300 is placed down over (e.g., in the direction “A” shown in FIG. 1C) the interposer assembly 200A. The first angled surface 251 (FIG. 2F) of the interlock detent 250 facilitates the interposer halo 300, and more particularly the compression rail 330, being snapped over the interlock detent 250 with a first amount of force. The second angled surface 252 of the interlock detent 250 prevents the interposer halo 300 from being removed from the interposer assembly 200A unless a second, and greater, amount of force is applied to remove it. The other interlock detents on the interposer assemblies 200A and 200B interface and interlock with the detent recesses on the inner surfaces of the compression rails 310 and 330 of the halo 300 in a similar way.

FIG. 3E illustrates the sectional view of the halo 300 designated B-B in FIG. 3A. The inner surface of the anchor end 340 is visible in FIG. 3E. The anchor end 340 includes clip recesses 343 and 344. The clip recesses 343 and 344 are formed as elongated cutout channels in the anchor end 340. When the latch clip 500 is installed over the plug connectors 400A and 400B and latched into the halo 300, the latching teeth 533 and 534 of the spring tab 532 will snap into the clip recesses 343 and 344 of the anchor end 340. The latching teeth 533 and 534 of the spring tab 532 will mechanically interfere with the top edges of the clip recesses 343 and 344, holding the latch clip 500 in place. The mechanical interference can be cleared by compression of the spring tab 532 against the extension arm 531 of the spring arm 530B. Latching teeth of the spring arm 530B also snap into the clip recesses 353 and 354 (FIG. 3C) of the halo 300 in a similar way, to hold the latch clip 500 in place.

FIG. 4A illustrates a top perspective view of the plug connector 400A shown in FIG. 1A, and FIG. 4B illustrates a bottom perspective view of the plug connector 400A. The plug connector 400A is illustrated as a representative example and is not drawn to any particular scale or size. The shape, size, proportion, and other characteristics of the plug connector 400A can vary as compared to that shown in other embodiments. The plug connector 400B can be the same as the plug connector 400A in some cases, although the plug connectors 400A and 400B can differ from each other in some cases. The plug connector 400A is positioned at the free end of an interconnect cable bundle, particularly at the free end of a cable bundle 450. The cable bundle 450 is not illustrated in FIG. 1A, for simplicity, but the cable bundle 450 is shown in FIGS. 4A, 4B, and other views. The cable bundle 450 includes rows of cables that are terminated to wafer assemblies within the plug connector 400A, as described in further detail below.

The plug connector 400A includes a plug housing 410, a plug housing cover 412, a cable bundle anchor 440, wafer assemblies secured within the plug housing 410, a plug conductive gasket 460, and possibly other components. The plug connector 400A has a mating interface 430 on one side as shown in FIG. 4B. The mating interface 430 of the plug connector 400A is positioned over and contacts the top surface 211 of the interposer assembly 200A, when the plug connector 400A is mated with the interposer assembly 200A. These and other aspects of the plug connector 400A are described below.

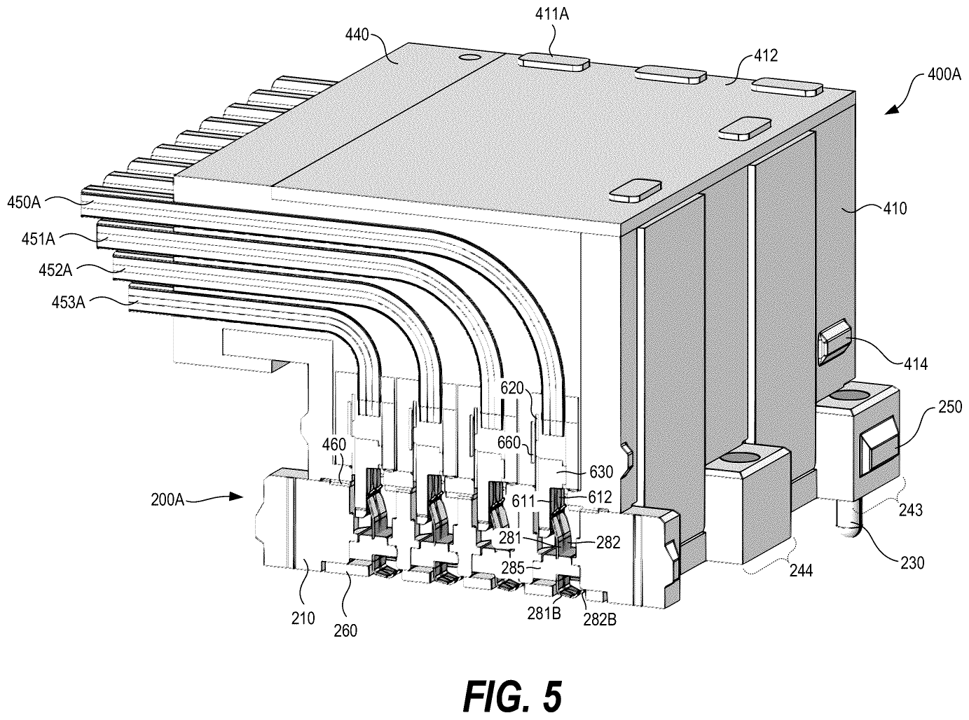

The plug connector 400A includes a number of wafer assemblies that are secured within the plug housing 410. The wafer assemblies are described in further detail below with reference to FIGS. 4D-4F. The signal and drain conductors of the cables in the cable bundle 450 are terminated, at one distal end, to the wafer assemblies within the plug housing 410. Terminal contact ends of the wafer assemblies extend outside of the plug housing 410 in the region of the mating interface 430, as shown in FIG. 4B. The terminal contact ends mate and electrically connect with the signal terminals in the interposer assembly 200A when the plug connector 400A is mated with the interposer assembly 200A, as also described below with reference to FIG. 5.

The plug housing 410 can be formed from a plastic or polymer, such as LCP, PE, PTFE, fluoropolymer, or other plastic or insulating material(s). The plug housing 410 can be formed using any suitable additive or subtractive manufacturing techniques, including molding, injection molding, printing, and other techniques. In some cases, surfaces or surface regions of the plug housing 410 can be plated with a plating metal or metals for conductivity, and the plug housing 410 can be embodied as a plated plastic component. As examples, the interior surfaces of the plug housing 410 (e.g., the exterior-facing surfaces within the plug housing) can be plated, exterior surfaces of the plug housing 410 can be plated, the region of the mating interface 430 can be plated, all exterior-facing surfaces of the plug housing 410 can be plated, or certain interior and/or exterior surface regions can be plated. The surfaces can be etched in some cases and metalized or plated in a bath, barrel plated, plated by PVD, electroless plating, electroplating, sputter plating, ion plating, or other plating techniques or a combination thereof. The surfaces of the plug housing 410 can be metalized or plated with copper, nickel, tin, silver, another other plating metal, or a combination of such plating metals. The plug housing 410 can also be formed of a conductive material, such as a metal or metal alloy, by casting or other additive or subtractive processing techniques.

The plug housing cover 412 can be formed from metal, such as a metal plate, in some cases. Thus, the plug housing cover 412 can form a type of ground shield for the plug connector 400A. The latch clip 500 can also be formed from metal, as described above, and the latch clip 500 can be electrically coupled to the plug housing cover 412 with contact between them. In another example, the plug housing cover 412 can be formed as a plated plastic component, similar to the plug housing 410. The plug housing cover 412 can be secured over the plug housing 410 by the anchors 411A-411C, among others, of the plug housing 410. The anchors 411A-411C extend through apertures in the plug housing cover 412 and are heat staked to secure the plug housing cover 412 in the example shown. The plug housing cover 412 can also be secured over the plug housing 410 in other ways, such as using an interference fit, snapping or interlocking features, or other suitable approaches.

The plug housing 410 includes alignment tabs 420-423, among others, that extend down along a periphery of the mating interface 430 of the plug connector 400A. The alignment tabs 420-423 fit into the slot recesses of the interposer housing 210. For example, referring between FIGS. 2B and 4A, the alignment tabs 422 and 423 of the plug housing 410 will fit into the slot recesses 246 and 247, respectively, of the interposer housing 210 when the plug connector 400A is mated with the interposer assembly 200A. The other alignment tabs of the plug housing 410 will also fit into other slot recesses around the periphery of the interposer housing 210. The plug housing 410, alignment tabs of the plug housing 410, interposer housing 210, and slot recesses of the interposer housing 210 are designed to permit only one mating orientation between the plug housing 410 and the interposer housing 210. Mechanical interferences between the alignment tabs and the slot recesses will prevent the plug connector 400A from mating with the interposer assembly 200A unless they are oriented (e.g., rotated) for the correct interface among the terminals between them.

The plug housing 410 also includes interference detents 414 and 415, among others. The interference detents 414 and 415 are positioned on one side of the plug housing 410, and additional interference detents can be positioned on the opposite side of the plug housing 410. The interference detents 414 and 415 contact and slide against the compression rails 310 and 330 of the halo 300, when the plug connector 400A is inserted through the central opening of the halo 300 for mating with the interposer assembly 200A. The interference detents 414 and 415 provide points of contact between the plug housing 410 and the compression rails 310 and 330 of the halo 300. The interference detents 414 and 415 also help to hold the plug connector 400A in place within the halo 300, based on a friction fit, before the latch clip 500 is installed over the plug connector 400A.

As shown in FIG. 4B, the conductive gasket 460 of the plug connector 400A is positioned and secured over the mating interface 430 of the plug housing 410. The conductive gasket 460 can be embodied as a conductive, elastomeric gasket formed from an elastic and compressible material, such as conductive foam. As one example, the conductive gasket 460 can be embodied as a polyurethane foam multi-laminate including conductive materials, such as copper, nickel, or other conductive metals or materials disposed therein. In one particular example, the conductive gasket 460 can be embodied as the P-SHIELD® brand PS-1323 conductive foam sheet or tape manufactured by Polymer Science, Inc. of Monticello, Indiana, although other suitable types of conductive elastomeric or foam materials can be relied upon. The conductive gasket 460 can range in thickness from between 0.1-5 mm, and example thicknesses include 0.5 mm, 1.0 mm, 1.5 mm, 2.0 mm, 2.5 mm, 2.5 mm, 3.0 mm, 3.5 mm, 4.0 mm, 4.5 mm, and 5.0 mm, although other thicknesses can be relied upon.

Due to its elastomeric properties, the conductive gasket 460 can be compressed against the top surface 211 of the interposer assembly 200A when the plug connector 400A is mated with the interposer assembly 200A. The conductive gasket 460 can make continuous contact with the top surface 211 of the interposer assembly 200A, even if the top surface 211 includes irregularities and does not extend in an exact plane. The enhanced shielding provided by the conductive gasket 460 helps to maintain signal integrity and higher data throughput for the contact interface assembly 100A. The conductive gasket 460 includes rows of apertures or openings, such as the opening 461, among others. The openings permit the signal terminal conductors of the wafer assemblies within the plug housing 410 to extend through the conductive gasket 460. Additional aspects of the conductive gasket 460 are described below.

The cable bundle anchor 440 can be formed from a plastic or polymer, such as LCP, PE, PTFE, fluoropolymer, or other plastic or insulating material(s) and can be metalized or plated with metal or a combination of plating metals in some cases. The cables in the cable bundle 450 extend through the cable bundle anchor 440 and into an interior space within the plug housing 410. In some cases, the cable bundle anchor 440 can be molded around the cables in the cable bundle 450, to provide strain relief, although the cables can be inserted through the cable bundle anchor 440 in other cases. The cable bundle anchor 440 can be secured to the plug housing 410 using an interference fit, adhesives, plastic welding or molding, other means, or combinations thereof.

The cable bundle 450 includes rows of cables, such as cables 450A-450N in a first row, and cables 451A, 452A, and 453A each in second, third, and fourth rows of cables in the cable bundle 450. The cable bundle 450 includes thirty-six (36) cables in the example shown, although the plug connector 400A can be modified for use with other numbers of cables. Each cable in the cable bundle 450 can be embodied as a twinaxial or twinax cable including a pair of signal conductors insulated by a central dielectric insulating material and one or more drain or ground conductors, suitable for high-speed differential data signaling applications. The cable bundle 450 can include other types of cables in other examples.

FIG. 4C illustrates the cable bundle 450 and the wafer assemblies 600-603 of the plug connector 400A shown in FIG. 4A. The plug housing 410, plug housing cover 412, and cable bundle anchor 440 are omitted from view in FIG. 4C. The wafer assemblies 600-603 are illustrated as representative examples and are not drawn to any particular scale or size. The shape, size, proportion, and other characteristics of the wafer assemblies 600-603 can vary as compared to that shown in other embodiments. The plug connector 400A includes four (4) wafer assemblies 600-603 in the example shown. The plug connector 400A can include other numbers of wafer assemblies in other cases, however, including fewer or greater numbers of wafer assemblies. Each of the wafer assemblies 600-603 includes similar components and can be formed and structured in the same way. Thus, while the components of the wafer assembly 600 are described in detail below, each of the wafer assemblies 601-603 can include the same components and structure as the wafer assembly 600.

Nine (9) cables among the cable bundle 450 are terminated to each of the wafer assemblies 600-603. For example, the cables 450A-450N are terminated at and to the wafer assembly 600. Each of the wafer assemblies 600-603 includes nine pairs of signal conductors and nine channel shields. Each pair of signal conductors extends within a channel of a respective channel shield, and each channel shield provides a common ground and shield for a pair of signal conductors. Each of the wafer assemblies 600-603 also includes a conductive cable clamp, a wafer overmold, and a number of conductor inserts. These and other aspects of the wafer assemblies 600-603 are described in further detail below.

FIG. 4D illustrates an exploded view of the wafer assembly 600 shown in FIG. 4C. The wafer assembly 600 includes a terminal assembly for each of the cables 450A-450N. Each terminal assembly includes a channel shield, a terminal insert, and a pair of terminal conductors. The wafer assembly 600 also includes a conductive cable clamp 640 (also “cable clamp 640”), a wafer overmold 650, an adhesive gasket 661, and a shield plate 660, among possibly other components. These and other aspects of the wafer assembly 600 are described in further detail below.

The wafer assembly 600 includes a channel shield for each of the cables 450A-450N in the example depicted, including the channel shields 620 and 621, among others. The channel shields 620 and 621 are common or ground shields in the wafer assembly 600. The channel shields 620 and 621 are formed as U-shaped shields in the examples depicted, although the channel shields 620 and 621 can be formed in other shapes. The channel shields 620 and 621 can be separately formed from (e.g., stamped, sheared, or otherwise formed out of) a flat sheet of metal material. Drain conductors of the cables 450A and 450B are electrically connected to the channel shields 620 and 621. Drain conductors of the other cables 450C-450N are also electrically connected to other channel shields in the wafer assembly 600.

The wafer assembly 600 also includes a terminal insert within each channel shield. For example, terminal inserts 630 and 631 are positioned within the channel shields 620 and 621, respectively. The terminal inserts 630 and 631 electrically isolate and support (e.g., provide a more rigid backing for) the two pairs of signal terminal conductors that extends within the channel shields 620 and 621. That is, the terminal insert 630 electrically isolates the terminal conductors 611 and 612 from each other and from the channel shield 620, and the terminal insert 630 supports the terminal conductors 611 and 612. The terminal insert 631 also electrically isolates and supports the terminal conductors 613 and 614.

The terminal conductors 611-614, among others in the wafer assembly 600, can be formed from (e.g., stamped, sheared, or otherwise formed out of) a flat sheet of metal, such as a lead frame. In some cases, the sheet of metal or lead frame can be plated with one or more plating metals. The terminal inserts 630 and 631, among others, can be formed from a plastic or polymer, such as LCP, PE, PTFE, fluoropolymer, or other plastic or insulating material(s). The terminal inserts 630 and 631 can be molded around the lead frame from which the terminal conductors 611-614 are formed, before the terminal conductors 611-614 are separated from the larger lead frame. The channel shields 620 and 621 can also be positioned around the terminal inserts 630 and 631, respectively, before the terminal inserts 630 and 631 and the terminal conductors 611-614 are separated from the lead frame. When the terminal inserts 630 and 631 are molded around the terminal conductors 611-614, the terminal inserts 630 and 631 can be formed to include staking posts. The staking posts are used to secure the terminal inserts 630 and 631 to the channel shields 620 and 621 during a heat staking process described below. The terminal inserts 630 and 631 secure and position the terminal conductors 611-614 with respect to each other and with respect to the channel shields 620 and 621.

The cable clamp 640 is secured and electrically coupled across the channel shields in the wafer assembly 600. The cable clamp 640 can be formed separately from a plastic or polymer, such as LCP, PE, PTFE, fluoropolymer, or other plastic or insulating material(s). The exterior-facing surfaces of the cable clamp 640 can be plated with a plating metal or metals for conductivity, and the cable clamp 640 can be embodied as a plated plastic component. The surfaces can be etched in some cases and metalized or plated in a bath, barrel plated, plated by PVD, electroless plating, electroplating, sputter plating, ion plating, or other plating techniques or a combination thereof. The surfaces of the cable clamp 640 can be metalized or plated with copper, nickel, tin, silver, another other plating metal, or a combination of such plating metals. In another example, the cable clamp 640 can be formed of a conductive material, such as a metal or metal alloy, by casting or other additive or subtractive processing techniques.

The cable clamp 640 includes a number of “C” shaped regions or depressions along one side. Each “C” shaped region fits a terminal assembly of the wafer assembly 600. The cable clamp 640 also includes slit channels at the sides of each “C” shaped region, for mechanical interface with the channel shields in the wafer assembly 600. For example, the cable clamp 640 includes slit channels 641 and 642 for interface with the channel shield 620, and the cable clamp 640 includes additional slit channels for interface with the other channel shields in the wafer assembly 600. The slit channels 641 and 642 are relatively narrow apertures through the cable clamp 640. The cable clamp 640 is positioned and secured over the channel shields of the wafer assembly 600, after each of the terminal assemblies is assembled.

When the cable clamp 640 is positioned over the channel shields, insert tabs of the channel shields extend into the slit channels of the cable clamp 640. The insert tabs of the channel shields fit into the slit channels of the cable clamp 640 with a friction or interference fit between them. The interference fit both secures and electrically connects the cable clamp 640 with the channel shields of the wafer assembly 600. For example, the channel shield 620 includes insert tabs 710 and 720, as shown in FIG. 4E, and the insert tabs 710 and 720 fit into the slit channels 641 and 642, respectively, providing an interference fit between the cable clamp 640 and the channel shield 620. A similar interference fit is also provided between each of the channel shields in the wafer assembly 600 and the cable clamp 640. Thus, the cable clamp 640 provides an additional electrical connection among the channel shields of the wafer assembly 600, to form a common ground among them. The cable clamp 640 helps to provide a common shield or ground network for the wafer assembly 600, as it electrically couples the channel shields together.

The adhesive gasket 661 and shield plate 660 are placed along the back surfaces of the channel shields of the wafer assembly 600. The adhesive gasket 661 can be embodied as an adhesive layer, adhesive film, adhesive strip, foam with adhesive film(s) or layer(s), conductive foam or gasket with adhesive film(s) or layer(s), or related adhesive gasket. The adhesive gasket 661 is relied upon to secure the shield plate 660 along and across the back surfaces of the channel shields of the wafer assembly 600. The shield plate 660 can be embodied as a conductive metal plate, and it serves as a ground shield that covers the weld openings in the back surfaces of the channel shields, as also described below.

After the cable clamp 640, the adhesive gasket 661, and the shield plate 660 are positioned and secured over the terminal assemblies at the ends of the cables 450A-450N, the wafer overmold 650 can be molded around them. The wafer overmold 650 can be a molded plastic or polymer. The wafer overmold 650 provides strain relief between the cables 450A-450N for the wafer assembly 600 and holds the wafer assembly 600 together. Outer surfaces of the cable clamp 640 and the shield plate 660 can be exposed around the wafer overmold 650. In other words, the wafer overmold 650 does not surround (or mold over) all the surfaces of the cable clamp 640 and the shield plate 660. Instead, surface regions of the cable clamp 640 and the shield plate 660 are exposed around the wafer overmold 650. The exposed regions of the cable clamp 640 and the shield plate 660 are conductive and electrically coupled to the drain conductors of all the cables 450A-450N. The exposed regions of the cable clamp 640 and the shield plate 660 can also be electrically coupled to conductive surfaces within the plug housing 410 in some cases and, ultimately, to the interposer assembly 200A when the plug connector 400A is mated with the interposer assembly 200A.

The wafer overmold 650 also includes channel guides 651 and 652, which are formed at the ends of the wafer overmold 650. The channel guides 651 and 652 fit into channel slots in the plug housing 410, to position the wafer assembly 600 in the plug housing 410, as described below with reference to FIG. 4G. The wafer overmold 650 also includes interference ribs 653 and 654, among others, which are formed on the front and back of the wafer overmold 650. The interference ribs 653 and 654 press against inner surfaces within the plug housing 410, to help secure the wafer assembly 600 in place within the plug housing 410, as also described below with reference to FIG. 4G.

The cable clamp 640 includes a lower ledge surface 645, as identified in FIG. 4D. A strip of conductive gasket 647 is secured to the lower ledge surface 645 when the wafer assembly 600 is assembled. The strip of conductive gasket 647 can be formed from the same material as the interposer conductive gasket 260, the plug conductive gasket 460, or a similar material. The strip of conductive gasket 647 can also contact and be electrically coupled to conductive surfaces within the plug housing 410 when the wafer assembly 600 is secured within the plug housing 410.

FIG. 4E illustrates a terminal assembly of the wafer assembly 600 shown in FIG. 4D, and FIG. 4F illustrates another view of the terminal assembly. As noted above, each cable in the cable bundle 450 can be embodied as a twinaxial or twinax cable, including a pair of signal conductors insulated by a central dielectric insulating material and one or more drain or common conductors. The terminal assembly shown in FIGS. 4E and 4F is positioned at one distal end of the cable 450A. As shown, the cable 450A includes signal conductors 670 and 671, drain conductors 680 and 681, an outer jacket 690, and a conductive shield 691. The distal end of the cable 450A is positioned, at least in part, within the channel of the channel shield 620.

The ends of the signal conductors 670 and 671 of the cable 450A can be coined and trimmed in some cases, as shown in FIG. 4E. The ends of the signal conductors 670 and 671 are electrically coupled to the terminal conductors 611 and 612. The signal conductors 670 and 671 of the cable 450A can be resistance welded, soldered, sintered, or otherwise electrically connected to the terminal conductors 611 and 612 in any suitable way. The channel shield 620 includes a weld opening 625 through the back of the channel shield 620 to facilitate resistance welding of the signal conductors 670 and 671 to the signal terminal conductors 611 and 612. The adhesive gasket 661 and the shield plate 660 (see FIG. 4D) are positioned and secured over the weld opening 625 in the channel shield 620, and over the other weld openings in the other channel shields of the wafer assembly 600, as an additional shield to maintain signal integrity.

The drain conductors 680 and 681 of the cable 450A also contact top edges of the channel shield 620 and are electrically coupled to the channel shield 620. The drain conductors 680 and 681 can be coupled to the channel shield 620 by contact, compression, resistance welding, soldering, sintering, or other suitable approaches. The cable clamp 640 shown in FIG. 4D will press and secure the drain conductors 680 and 681 against the upper edges of the channel shield 620 in the positions shown in FIGS. 4E and 4F when secured to the channel shield 620.

The channel shield 620 also contacts the conductive shield 691 of the cable 450A. As shown in FIG. 4F, for example, the contact dimple 700 of the channel shield 620 has a raised profile from the back of the channel shield 621 and contacts the conductive shield 691 of the cable 450A. Thus, the channel shield 620 is electrically coupled to both the drain conductors 680 and 681 and the conductive shield 691 of the cable 450A, and the channel shield 620 provides a ground shield for the terminal conductors 611 and 612. The cable clamp 640 and the shield plate 660 also provide ground shields for the wafer assembly 600.

FIG. 4F illustrates a staking cap 635 of the terminal insert 630. When the terminal insert 630 is molded around the terminal conductors 611 and 612, the terminal insert 630 can be formed to include a staking post. The staking post extends through an opening in the channel shield 620 and is heat staked to form the staking cap 635. The staking cap 635 helps to secure the terminal insert and terminal conductors 611 and 612 within the channel shield 620.

The channel shield 620 also includes the insert tabs 710 and 720 along the side edges of the channel shield 620. The insert tabs 710 and 720 include interference bumps. The insert tab 710 includes interference bumps 721 and 722 at the top and the bottom of the insert tab 710, and the insert tab 720 includes similar interference bumps. When the cable clamp 640 is positioned over the channel shield 620, the insert tabs 710 and 720 of the channel shield 620 extend into the slit channels 641 and 642 (see FIG. 4D) of the cable clamp 640, respectively. The insert tabs 710 and 720 and interference bumps 721 and 722 provide an interference fit between the cable clamp 640 and the channel shield 620. A similar interference fit is also provided between each of the channel shields in the wafer assembly 600 and the cable clamp 640. Thus, the cable clamp 640 electrically commons or ties the potentials among all the channel shields in the wafer assembly 600 together. The cable clamp 640 can help to reduce signal interference among the data signals carried on the wafer assembly 600, facilitating higher data throughput in the plug connector 400A.

The channel shield 620 also includes grounding bumps 730 and 740, and the other channel shields in the wafer assembly 600 include similar grounding bumps. The grounding bumps 730 and 740 are exposed and outside of the wafer overmold 650. When the wafer assembly 600 is inserted into the plug housing 410, as described below, the grounding bumps 730 and 740 contact and are electrically coupled to conductive surfaces within the plug housing 410.

FIG. 4G illustrates a top and internal view of the plug housing 410 of the plug connector 400A shown in FIG. 4A. The plug housing 410 includes regions in which each of the wafer assemblies 600-603 can be seated and secured. For example, the wafer assembly 600 can be secured in the region 800 within the plug housing 410, and the wafer assemblies 601-603 can be secured in similar regions, in a side-by-side arrangement, within the plug housing 410.

The plug housing 410 includes apertures 810A-810N in the region 800. The extension end 630A (see FIG. 4E) of the terminal insert 630, with the terminal conductors 611 and 612, extends through the aperture 810A. The extension ends of the other terminal assemblies of the wafer assembly 600 also fit through the other apertures 810B-810N in the region 800. The channel guides 651 and 652 (see FIG. 4D) of the wafer overmold 650 fit and slide into the channel slots 820 and 821 at the ends of the region 800. The channel guides 651 and 652 of the wafer assembly 600 position the wafer assembly 600 in the plug housing 410 based on the pathways provided by the channel slots 820 and 821. The interference ribs 653 and 654 (see FIG. 4D), among others, of the wafer overmold 650, can also press against inner surfaces within the plug housing 410, to help secure the wafer assembly 600 in place within the plug housing 410.

The plug housing 410 is a plated plastic component in preferred embodiments. The surfaces of the plug housing 410 act as both a ground shield and a ground return path. At the same time, surfaces of the wafer assembly 600 are conductive and tied to an electrical common or ground potential of the wafer assembly 600, as described above. For example, surfaces of the cable clamp 640, the shield plate 660, the grounding bumps of the channel shields, and other surfaces of the wafer assembly 600 are conductive and tied to an electrical common or ground potential of the wafer assembly 600. The surfaces of the wafer assembly 600 that are tied to the electrical common or ground potential of the wafer assembly 600 also electrically contact the surfaces of the plug housing 410, within the plug housing 410. Those surfaces are also electrically coupled to the mating interface 430 of the plug connector 400A and the plug conductive gasket 460.

FIG. 5 illustrates the sectional view through the plug connector 400A and the interposer assembly 200A designated C-C in FIG. 1A. FIG. 5 illustrates how the plug connector 400A can be mated with the interposer assembly 200A. The extension ends of the terminal assemblies of the wafer assemblies of the plug connector 400A extend into the terminal opening in the interposer assembly 200A. Within those terminal openings in the interposer assembly 200A, the signal terminal conductors of the terminal pair plugs in the interposer assembly 200A electrically contact the signal terminal conductors of the terminal assemblies. For example, the signal terminal conductors 611 and 612 of the terminal assembly shown in FIGS. 4E and 4F contact the signal terminal conductors 281 and 282 of the terminal pair plug 280 shown in FIGS. 2J and 2K. FIG. 5 also illustrates the plug conductive gasket 460 between the plug housing 410 and the interposer housing 210, as well as the interposer conductive gasket 260, which is positioned below the interposer housing 210 for contact to the top surface 24 of the PCB 20.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,”“collinear,”“coplanar,”and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A compression contact interface assembly, comprising:
an interposer assembly, the interposer assembly comprising an interposer housing and an interposer conductive gasket positioned over a board-mating interface region of the interposer housing;
a halo for securing the interposer assembly to a printed circuit board (PCB);
a plug connector that mates with the interposer assembly; and
a latch clip that extends over the plug connector, clips into the halo, and secures the plug connector in a mated position with the interposer assembly.

2. The compression contact interface assembly according to claim 1, wherein:
the interposer housing is plated with metal; and
the interposer conductive gasket and the interposer housing comprise a ground return path for the interposer assembly and the compression contact interface assembly.

3. The compression contact interface assembly according to claim 1, wherein:
the interposer housing further comprises a terminal opening that extends from a top surface to a bottom surface of the interposer housing;
a terminal pair plug is secured within the terminal opening; and
a terminal conductor of the terminal pair plug extends into an opening of the interposer conductive gasket.

4. The compression contact interface assembly according to claim 1, wherein the interposer housing further comprises an alignment stub and an interlock detent on an outer surface of the alignment stub.

5. The compression contact interface assembly according to claim 1, wherein the interposer housing further comprises an alignment pin secured with the interposer housing and extending beyond an outer surface of the interposer housing.

6. The compression contact interface assembly according to claim 1, wherein the halo comprises anchor ends and compression rails that extend between the anchor ends.

7. The compression contact interface assembly according to claim 6, wherein the compression rails comprise stub recesses and detent recesses.

8. The compression contact interface assembly according to claim 6, wherein the anchor ends comprise clip recesses.

9. The compression contact interface assembly according to claim 1, wherein:
the halo comprises clip recesses;
the latch clip comprises spring arms with latching teeth; and
the latching teeth of the latch clip mechanically interfere into the clip recesses of the halo.

10. The compression contact interface assembly according to claim 1, wherein:
the plug connector comprises a wafer assembly; and
the wafer assembly comprises:
a channel shield;
a pair of signal terminals extending within the channel shield; and
a terminal insert extending within the channel shield.

11. The compression contact interface assembly according to claim 1, wherein:
the plug connector comprises a plug housing, a plug conductive gasket positioned over a mating interface of the plug housing, and a wafer assembly positioned in the plug housing; and
the wafer assembly comprises:
a plurality of channel shields and signal terminals extending within the channel shields; and
a conductive cable clamp that extends over and is electrically coupled to the plurality of channel shields.

12. The compression contact interface assembly according to claim 1, wherein:
the plug connector comprises a wafer assembly; and
the wafer assembly comprises:
a plurality of channel shields and signal terminals extending within the channel shields;
a conductive cable clamp that extends over and is electrically coupled to the plurality of channel shields;
a shield plate that extends over and is electrically coupled to the plurality of channel shields; and
a wafer overmold.

13. A connector assembly, comprising:
an interposer assembly; and
a plug connector that mates with the interposer assembly, the plug connector comprising a plug housing and a plug conductive gasket positioned over a mating interface of the plug housing.

14. The connector assembly according to claim 13, wherein:
the interposer assembly comprises an interposer housing and an interposer conductive gasket positioned over a board-mating interface region of the interposer housing;
the interposer housing is plated with metal; and
the interposer conductive gasket and the interposer housing comprise a ground return path for the interposer assembly and the connector assembly.

15. The connector assembly according to claim 14, wherein:
the interposer housing further comprises a terminal opening that extends from a top surface to a bottom surface of the interposer housing;
a terminal pair plug is secured within the terminal opening; and
a terminal conductor of the terminal pair plug extends into an opening of the interposer conductive gasket.

16. The connector assembly according to claim 13, wherein:
the plug connector further comprises a wafer assembly positioned in the plug housing; and
the wafer assembly comprises:
a plurality of channel shields and signal terminals extending within the channel shields;
a conductive cable clamp that extends over and is electrically coupled to the plurality of channel shields;
a shield plate that extends over and is electrically coupled to the plurality of channel shields; and
a wafer overmold.

17. The connector assembly according to claim 13, further comprising:
a halo for securing the interposer assembly to a printed circuit board (PCB); and
a latch clip that extends over the plug connector, clips into the halo, and secures the plug connector in a mated position with the interposer assembly.

18. A compression contact interface assembly, comprising:
an interposer assembly;
a halo for securing the interposer assembly to a printed circuit board (PCB);
a plug connector that mates with the interposer assembly; and
a latch clip that secures the plug connector in a mated position with the interposer assembly.

19. The compression contact interface assembly according to claim 18, wherein the plug connector further comprises a plug housing and a plug conductive gasket positioned over a mating interface of the plug housing.

20. The compression contact interface assembly according to claim 18, wherein the interposer assembly comprises an interposer housing and an interposer conductive gasket positioned over a board-mating interface region of the interposer housing.
